(19) United States
(12) Patent Application Publication
(10) Pub. No.: US 2026/0230985 A1
(43) Pub. Date: Aug. 6, 2026

(54) ACCESS AND MOBILITY MANAGEMENT FUNCTION, AMF, SHARED RADIO ACCESS NETWORK, RAN, AND METHOD

(71) Applicant: NEC Corporation, Tokyo (JP)

(72) Inventors: Toshiyuki TAMURA, Ibaraki (JP); Sadafuku HAYASHI, Tokyo (JP); Iskren IANEV, Reading (GB); Kundan TIWARI, Bengaluru (IN); Hisashi FUTAKI, Tokyo (JP)

(73) Assignee: NEC Corporation, Tokyo (JP)

(21) Appl. No.: 19/151,346

(22) PCT Filed: Jan. 26, 2024
(86) PCT No.: PCT/JP2024/002310

§ 371 Date: Jul. 28, 2025

(30) Foreign Application Priority Data
Feb. 2, 2023 (IN) 202311006779

(51) Int. Cl. H04W 36/32; H04L 5/00; H04W 36/00; H04W 84/04

(52) U.S. Cl. CPC H04W 36/326; H04L 5/0053; H04W 36/008357; H04W 84/042

(57) ABSTRACT

An aspect of this disclosure includes a method of a radio communication apparatus. The method includes communicating with a core network apparatus. The method includes receiving from the core network apparatus, first information indicating a Public Land Mobile Network (PLMN) to be added as a PLMN which shares a Radio Access Network (RAN). The RAN adds the PLMN based on the first information. An aspect of this disclosure includes a method of the core network apparatus. The method includes communicating with the radio communication apparatus. The method includes transmitting to the radio communication apparatus, first information indicating a Public Land Mobile Network (PLMN) to be added as a PLMN which shares a Radio Access Network (RAN).

### TECHNICAL FIELD

The present disclosure relates to a method of a radio communication apparatus, and a core network apparatus. The radio communication apparatus adds a Public Land Mobile Network, PLMN, which shares a Radio Access Network (RAN) by communicating with the core network.

### BACKGROUND ART

According to the 3GPP contribution SP-220087 (NPL 2), 3GPP SA1 studies an existing issue on deploying network sharing (i.e. MOCN) as summarized below.
When developing network sharing (i.e. MOCN), one of the challenges for the partners' network operators is related with the maintenance generated by the interconnection (e.g., number of network interfaces) between the shared RAN and two or more core networks, especially for a very large number of shared base stations.

In order to solve this issue, network operators seek a solution with other type of network sharing scenarios, where a 5G RAN is shared among multiple operators without necessarily assuming a direct link between shared access and core network (e.g., no N2 link).

### CITATION LIST

### Non Patent Literature

NPL 1: 3GPP TR 21.905: “Vocabulary for 3GPP Specifications”. V17.1.0 (2021-12)
NPL 2: SP-220087: https://www.3gpp.org/ftp/tsg_sa/TSG_SA/TSGS_95E_Electronic_2022_03/Docs/S P-220087.zip
NPL 3: 3GPP TS 23.501: “System architecture for the 5G System (5GS)”. V18.0.0 (2022-12)
NPL 4: 3GPP TS 23.502: “Procedures for the 5G System (5GS)”. V 18.0.0 (2022-12)
NPL 5: 3GPP TS 23.503: “Policy and charging control framework for the 5G System (5GS) Stage 2”. V18.0.0 (2022-12)
NPL 6: 3GPP TS 24.501: “Non-Access-Stratum (NAS) protocol for 5G System (5GS) Stage 3”. V18.1.0 (2022-12)
NPL 7: 3GPP TS 38.413: “NG-RAN; NG Application Protocol (NGAP)”. V17.2.0 (2022-09)
NPL 8: 3GPP TS 38.423:“NG-RAN; Xn application protocol (XnAP)”. V 17.2.0 (2022-09)
NPL 9: 3GPP TS 29.281: “General Packet Radio System (GPRS) Tunnelling Protocol User Plane (GTPv1-U)”. V17.4.0 (2022-09)
NPL 10: 3GPP TS 38.331: “NR; Radio Resource Control (RRC) protocol specification”. V17.2.0 (2022-09)
NPL 11: 3GPP TS 23.032: “Universal Geographical Area Description (GAD”. V17.2.0 (2021-12)
NPL 12: RFC 5139: https://www.rfc-editor.org/rfc/rfc5139
NPL 13: 3GPP TS 38.401: “NG-RAN; Architecture description”. V17.3.0 (2022-12)

### SUMMARY OF INVENTION

### Technical Problem

When developing network sharing (i.e. MOCN), one of the challenges for the partners' network operators is related with the maintenance generated by the interconnection (e.g., number of network interfaces) between the shared RAN and two or more core networks, especially for a very large number of shared base station.

In order to maximize a benefit of the networks sharing technologies, a shared network should be configured easily and dynamically with less maintenance efforts.

### Solution to Problem

A fist aspect of the present disclosure provides a first Access and Mobility Management Function (AMF), belonging to a first Public Land Mobile Network (PLMN), including:
a receiver configured to receive, from a second AMF belonging a second PLMN, a first message including at least first information associated with a proxy request,
a processor configured to select at least one shared Radio Access Network (RAN) from among multiple shared RAN candidates,
a transmitter configured to transmit, to the at least one selected shared RAN, a second message including at least second information associated with the proxy request,
the receiver configured to receive, from the at least one selected shared RAN, an acknowledge message, and
the transmitter configured to transmit, to the second AMF, a third message including at least third information associated with the at least one selected shared RAN.

A second aspect of the present disclosure provides a shared Radio Access Network (RAN) including:
a receiver configured to receive, form a first Access and Mobility Management Function (AMF) belonging to a first Public Land Mobile Network (PLMN), a second message including at least second information associated with a proxy request,
a transmitter configured to transmit, to the first AMF, an acknowledge message, wherein
the receiver is configured to receive, from a user equipment (UE), a Radio Resource Control (RRC) message including at least a selected Public Land Mobile Network (PLMN)-Identity, and
a processor is configured to determine whether to transmit a first Next Generation Application Protocol (NGAP) message, to a second AMF belonging to a second PLMN, directly or via the first AMF.

A third aspect of the present disclosure provides a second Access and Mobility Management Function (AMF), belonging to second Public Land Mobile Network (PLMN), including:
a transmitter configured to transmit, to a first AMF belonging a first PLMN, a first message including at least first information associated with a proxy request, a receiver configured to receive, from the first AMF, a third message including at least third information associated with at least one shared RAN, the at least one shared RAN being selected by the first AMF,
a processor configured to determine whether to transmit a Next Generation Application Protocol (NGAP) message, to the at least one shared RAN, directly or via the first AMF.

A fourth aspect of the present disclosure provides a method for a first Access and Mobility Management Function (AMF), belonging to a first Public Land Mobile Network (PLMN), the method including:
receiving, from a second AMF belonging a second PLMN, a first message including at least first information associated with a proxy request,
selecting at least one shared Radio Access Network (RAN) from among multiple shared RAN candidates,
transmitting, to the at least one selected shared RAN, a second message including at least second information associated with the proxy request,
receiving, from the at least one selected shared RAN, an acknowledge message, and
transmitting, to the second AMF, a third message including at least third information associated with the at least one selected shared RAN.

A fifth aspect of the present disclosure provides a method for a shared Radio Access Network (RAN), the method including:
receiving, form a first Access and Mobility Management Function (AMF) belonging to a first Public Land Mobile Network (PLMN), a second message including at least second information associated with a proxy request,
transmitting, to the first AMF, an acknowledge message,
receiving, from a user equipment (UE), a Radio Resource Control (RRC) message including at least a selected Public Land Mobile Network (PLMN)-Identity, and
determining whether to transmit a first Next Generation Application Protocol (NGAP) message, to a second AMF belonging to a second PLMN, directly or via the first AMF.

A sixth aspect of the present disclosure provides a method for a second Access and Mobility Management Function (AMF), belonging to second Public Land Mobile Network (PLMN), the method including:
transmitting, to a first AMF belonging a first PLMN, a first message including at least first information associated with a proxy request,
receiving, from the first AMF, a third message including at least third information associated with at least one shared RAN, the at least one shared RAN being selected by the first AMF,
determining whether to transmit a Next Generation Application Protocol (NGAP) message, to the at least one shared RAN, directly or via the first AMF.

### BRIEF DESCRIPTION OF DRAWINGS

FIG. 1 is a network configuration of a First example of the First Aspect.

FIG. 2 is a protocol stacks for control plane of a First example of the Firsts Aspect.

FIG. 3 is a protocol stacks for user plane of a First example of the Firsts Aspect.

FIG. 4 is a signaling diagram of a Second example of the First Aspect.

FIG. 5 is a first signaling diagram of a Third example of the First Aspect.

FIG. 6 is a second signaling diagram of a Third example of the First Aspect.

FIG. 7 is a signaling diagram of a Fourth example of the First Aspect.

FIG. 8 is a signaling diagram of a Fifth example of the First Aspect.

FIG. 9 is a signaling diagram of a Sixth example of the First Aspect.

FIG. 10 is a first part of signaling diagram of a Seventh example of the First Aspect.

FIG. 11 is a second part of signaling diagram of a Seventh example of the First Aspect.

FIG. 12 is a user data handling illustration of a Seventh example of the First Aspect.

FIG. 13 is a signaling diagram of a Ninth example of the First Aspect.

FIG. 14 is a signaling diagram of a Tenth example of the First Aspect.

FIG. 15 is a diagram illustrating a system overview.

FIG. 16 is a block diagram illustrating a UE.

FIG. 17 is a block diagram illustrating an (R)AN node.

FIG. 18 is a diagram illustrating System overview of (R)AN node based on O-RAN architecture.

FIG. 19 is a block diagram illustrating an RU.

FIG. 20 is a block diagram illustrating a DU.

FIG. 21 is a block diagram illustrating a CU.

FIG. 22 is a block diagram illustrating an AMF.

FIG. 23 is a block diagram illustrating a PCF.

FIG. 24 is a block diagram illustrating an AUSF.

FIG. 25 is a block diagram illustrating a UDM.

FIG. 26 is a block diagram illustrating an NSSF.

### DESCRIPTION OF EMBODIMENTS

### Abbreviations

For the purposes of the present document, the abbreviations given in 3GPP TR 21.905 (NPL 1) and the following apply. An abbreviation defined in the present document takes precedence over the definition of the same abbreviation, if any, in NTP 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function
ARFCN Absolute radio-frequency channel number
AS Access Stratum
ASN Abstract Syntax Notation
ATSSS Access Traffic Steering, Switching, Splitting
ATSSS-LL ATSSS Low-Layer
AuC Authentication Centre
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
G-PDU GTP encapsulated user Plane Data Unit
GPS Global Positioning System
GPSI Generic Public Subscription Identifier
GUAMI Globally Unique AMF Identifier
GUTI Globally Unique Temporary UE Identity
HPLMN Home Public Land Mobile Network
HR Home Routed (roaming)
HSS Home Subscriber Server
IAB Integrated access and backhaul
IPsec Internet Protocol Security
IMEI/TAC IMEI Type Allocation Code
IMSI International Mobile Subscriber Identity
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
ME Mobile Equipment
MFBR Maximum Flow Bit Rate
MICO Mobile Initiated Connection Only
MINT Minimization of service interruption
MITM Man In the Middle
MME Mobility Management Entity
MNC Mobile Network Code
MOCN Multiple Operator Core Network
MPS Multimedia Priority Service
MPTCP Multi-Path TCP Protocol
MT Mobile Termination
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NMEA National Marine Electronics Association
NPN Non-Public Network
NR New Radio
NSAG Network Slice Access Stratum Group
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PCO Protocol Configuration Options
PCRF Policy and Charging Rules Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RRC Radio Resource Control
RSN Redundancy Sequence Number
RSRP Reference Signal Received Power
RSRQ Reference Signal Received Quality
SA NR Standalone New Radio
SBA Service Based Architecture
SBI Service Based Interface
SCP Service Communication Proxy
SD Slice Differentiator
SEAF Security Anchor Functionality
SENSE Signal Level Enhanced Network Selection
SEPP Security Edge Protection Proxy
SGW Serving Gateway
SIB System Information Block
SINR Signal to Interference plus Noise Ratio
SMF Session Management Function
SMSF Short Message Service Function
SN Sequence Number
SN name Serving Network Name.
SNPN Stand-alone Non-Public Network
S-NSSAI Single Network Slice Selection Assistance Information
SOR Steering of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAU Tracking Area Update
TEID Tunnel Endpoint Identifier
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
UPSI UE Policy Section Identifier
URLLC Ultra Reliable Low Latency Communication
URRP-AMF UE Reachability Request Parameter for AMF
URSP UE Route Selection Policy
USIM User Services Identity Module
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects (i.e. First Aspect, Second Aspect, Third Aspect, First example of the First Aspect, Second example of the First Aspect, Third example of the First Aspect, First example of the Second Aspect, Second example of the Second Aspect, Third example of the Second Aspect, Variant of each Aspects) and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

Any lists described in following aspects include at least one parameter or multiple parameters.

An example object of this disclosure is to provide a method and apparatus that can solve the above problem.

Although this disclosure discloses a mechanism in the shared RAN environment that enables to add a PLMN that is not directly interconnected to the shared RAN in the 5GS, all mechanisms in this disclosure can apply to the EPS as well. In case all mechanisms in this disclosure are to apply to the EPS, the following terminology conversions apply:
gNB→eNodeB
AMF→MME
Proxy AMF→Proxy MME
UPF→SGW or SGW-U
UDM→HSS
NGAP→S1AP
N2 reference point→S1-MME reference point
N3 reference point→S1-U reference point
N9 reference point→S5 or S8 reference point
N14 reference point→S10 reference point
NG SETUP REQUEST message→S1 SETUP REQUEST message
NG SETUP RESPONSE message→S1 SETUP RESPONSE message
XN SETUP REQUEST message→S2 SETUP REQUEST message
XN SETUP RESPONSE message→S2 SETUP RESPONSE message
AMF CONFIGURATION UPDATE message→MME CONFIGURATION UPDATE message
AMF CONFIGURATION UPDATE ACKNOWLEDGE→MME CONFIGURATION UPDATE ACKNOWLEDGE message
RAN CONFIGURATION UPDATE message→ENB CONFIGURATION UPDATE message
RAN CONFIGURATION UPDATE ACKNOWLEDGE→ENB CONFIGURATION UPDATE ACKNOWLEDGE message
Any NGAP messages→Respective S1AP messages
Registration Request message→Attach Request message or TAU Request message
Any AMF service-related messages (ex. Namf_Communication_NonUeN2InfoNotify)→GTP-C messages
5G-GUTI→GUTI
5G-S-TMSI→S-TMSI
PDU Session ID→TEID or TEID and IP address

### First Aspect

This aspect discloses a mechanism in the shared RAN environment that enables to add the AMF 7002, which is located in another PLMN, as a core network entity which shares the RAN 5 without a direct link between the shared RAN 5 and the AMF 7002.

Similarly, the mechanism in the shared RAN environment that enables to add a UPF 7202, which is located in another PLMN, as a core network entity which shares the RAN 5 without a direct link between shared the RAN 5 and the UPF 7202.

### First Example of the First Aspect

The First example of the First Aspect discloses a Proxy AMF/Proxy UPF based interworking architecture for RAN sharing.

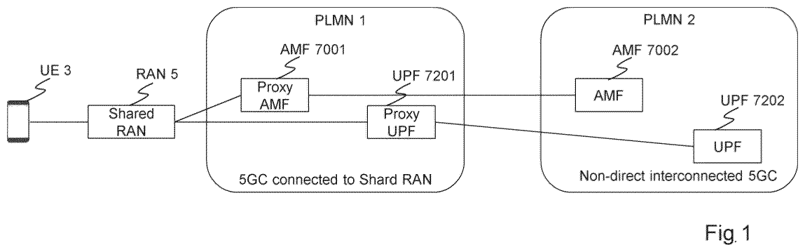

FIG. 1 explains an example of the Proxy AMF/Proxy UPF based interworking architecture for RAN sharing.

The Proxy AMF 7001 and the Proxy UPF 7201 are connected to the shared RAN 5 and interwork with AMF 7002 and UPF 7202 respectively which reside in another PLMN, e.g. PLMN 2.

With this architecture, the AMF 7002 and UPF 7202 in another PLMN can interwork with the shared RAN 5 via the Proxy AMF 7001 and the Proxy UPF 7201 respectively.

The PLMN 1 in FIG. 1 can be considered as the Direct interconnected 5GC where core network nodes, for example AMF 7001 and UPF 7201 in FIG. 1, have a direct connection with the Shared RAN 5 based on the reference points, for example N2 reference point and N3 reference point, as defined by the 3GPP TS 23.501 (NPL 3). The direct connection can be expressed differently, for example, direct link, direct reference point, direct N2 reference point, direct N3 reference point, direct NGAP connection, direct GTP-U connection.

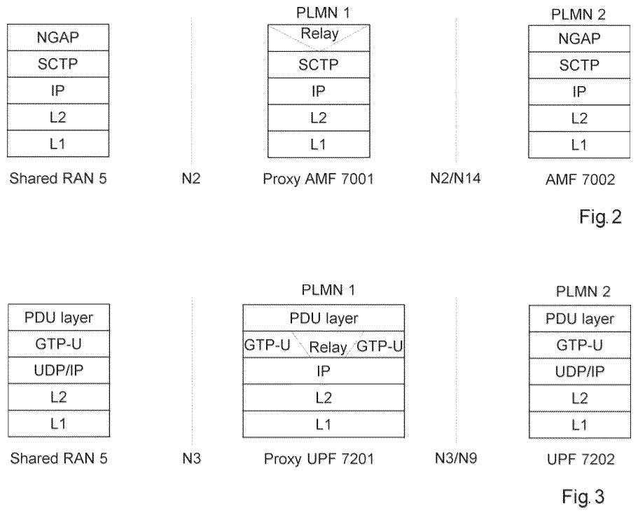

On the other hand, the PLMN 2 in FIG. 1 can be considered as the non-direct interconnected 5GC, where core network nodes, for example AMF 7002 and UPF 7202 in FIG. 2, do not have a direct connection with the Shared RAN 5 based on the reference points, for example N2 reference point and N3 reference point, as defined by NPL 3. Core network nodes in the non-direct interconnected 5GC can only communicate with the Shared RAN 5 with intervening the Direct interconnected 5GC that has the direct connection with the Shared RAN 5.

The Proxy AMF 7001 may be a normal AMF in the PLMN 1 and the functionalities that are disclosed by the First Aspect are built-in to the normal AMF.

The Proxy AMF 7001 may be a standalone AMF with the functionalities that are disclosed by the First Aspect.

The Proxy AMF 7001 may not belong to the PLMN 1. The Proxy AMF 7001 can be managed by multiple operators, a 3^{rd} party that owns the Shared RAN or authorities who are responsible for sharing RANs.

The Shared RAN 5 may belong to the PLMN 1. The Shared RAN 5 may not belong to the PLMN 1.

The Shared RAN 5 may belong to multiple operators, a 3^{rd} party that owns the Shard RAN or authorities who are responsible for sharing RANs.

Similarly, the UPF 7202 in the PLMN 2 can interwork with the Shared RAN 5 via the Proxy UPF 7201 in the PLMN 1. In one example, the UPF 7202 in the PLMN 2 may directly connect to the Shared RAN 5 depending on an agreement between the PLMN 1 and the PLMN 2.

The Proxy UPF 7201 may be a normal UPF in the PLMN 1 and the functionalities that are disclosed by the First Aspect are built-in to the normal UPF. The Proxy UPF 7201 may be a standalone UPF with the functionalities that are disclosed by the First Aspect.

In case where multiple Proxy AMFs 7001 are deployed in the PLMN 1 per geographical location or/and per frequency bands, the AMF 7002 may have multiple associations with the Proxy AMF 7001.

FIG. 2 illustrates the protocol stacks among the shared RAN 5, the Proxy AMF 7001 and the AMF 7002.

The AMF 7002 in the PLMN 2 interworks with the Proxy AMF 7001 in the PLMN 1 using the Service Based Interworking (SBI) over the N14 reference point as defined in the 3GPP TS 23.502 (NPL 4).

In addition, the AMF 7002 in the PLMN 2 interworks with the Shared RAN 5 using the NGAP protocol as defined in the 3GPP TS 38.413 (NPL 7).

When the Proxy AMF 7001 receives an NGAP message from the Shared RAN 5 bound for the AMF 7002, The Proxy AMF 7001 embeds the received NGAP message into an SBI message and sends the SBI message to the AMF 7002. Then, the AMF 7002 extracts the NGAP message from the received SBI message.

In the opposite direction, when the Proxy AMF 7001 receives an SBI message with an NGAP message embedded in the SBI message from the AMF 7002, the Proxy AMF 7001 extracts the NGAP message and sends it to the Shared RAN 5.

FIG. 3 illustrates the protocol stacks among the shared RAN 5, the Proxy UPF 7201 and the UPF 7202.

The UPF 7202 in the PLMN 2 interworks with the Proxy UPF 7201 in the PLMN 1 using the GTP-U protocol as defined in the 3GPP TS 29.281 (NPL 10).

When the Proxy UPF 7201 receives a GTP-U message from the Shared RAN 5 bound for the UPF 7202, the Proxy UPF 7201 transfers the G-PDU in the received GTP-U message to the UPF 7202 by putting it into the GTP-U message over the N3 or N9 reference point.

In the opposite direction, when the Proxy UPF 7201 receives a GTP-U message from the UPF 7202, the Proxy UPF 7201 transfers the G-PDU in the received GTP-U message to the Shared RAN 5 by putting it into the GTP-U message over the N3 reference point.

### Second Example of the First Aspect

This example discloses a procedure for connecting the AMF 7002 to the Shared RANs via the Proxy AMF 7001.

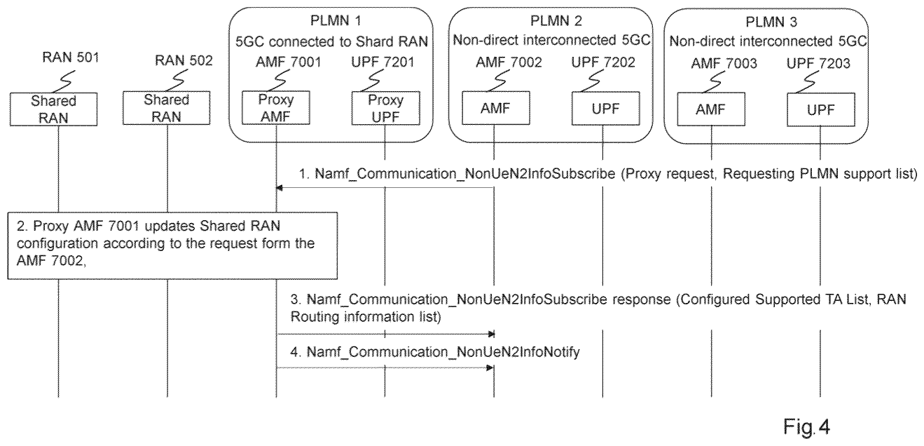

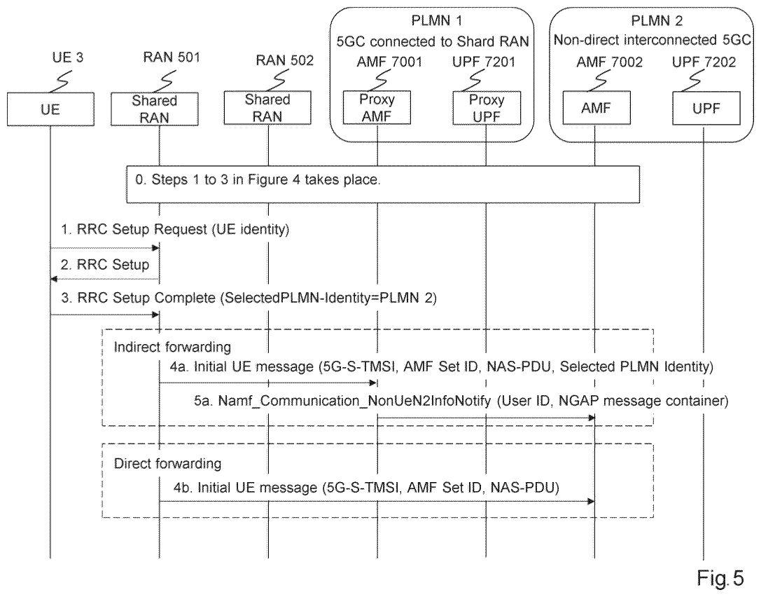

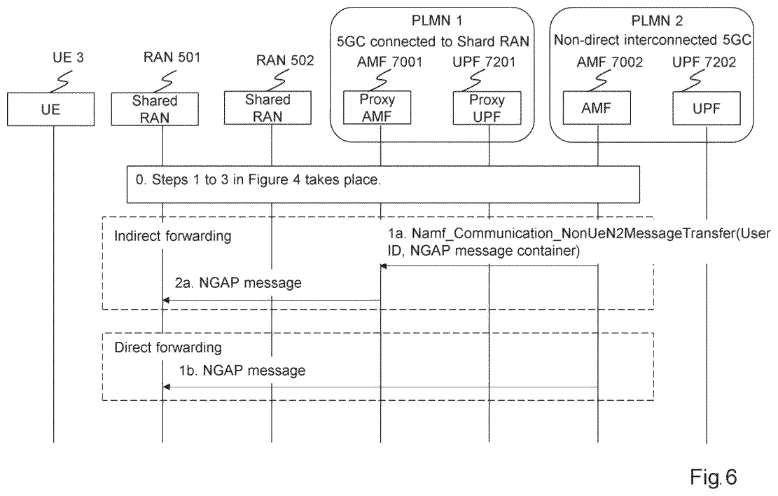

The detailed processes of the Second example of the First Aspect are described below with reference to FIG. 4.
Step 1. The AMF 7002 sends the Namf_Communication_NonUeN2InfoSubscribe message to the Proxy AMF 7001 including the Proxy request and Requesting PLMN support list. The Proxy request indicates that the AMF 7002 requests the Proxy AMF 7001 to become an AMF Proxy for RAN sharing. The Requesting PLMN support list indicates detail configuration parameters how the RAN to be shared with the AMF 7002. The Requesting PLMN support list includes a list of supported PLMNs with the AMF 7002. Each entry in the PLMN Support list may include the following information.
   Mobile Country Code (MCC)
   Mobile Network Code (MNC)
   Requesting Served GUAMI item: This is a list of AMF identities that are being requested for the RAN Sharing. Each entry in the Requesting Served GUAMI item may include AMF name, Routing information (Ex. FQDN or IP address and etc.) to each AMF. PLMN Identity, Slice Support List, NPN Support, Extended Slice Support List, Onboarding Support as defined in NPL 7. If the Routing information is an IP address, the IP address may be IPv4 address or IPv6 address.
   Requesting radio configuration: The Requesting radio configuration indicates a detailed information about where and how the Shared RAN to be configured. This information may include the following information.
      Geographical area: The Geographical area indicates a coverage area where the corresponding PLMN requests to cover. This information may be represented with at least one from the followings:
         Universal Geographical Area Description (GAD) as defined in 3GPP TS 23.032 (NPL 11).
         NMEA format as used by the GPS system.
         Revised Civic Location Format for Presence Information Data Format Location Object as defined in RFC 5139 (NPL 12)
      Frequency band list: The Frequency band list indicates a list of Frequency bands that the corresponding PLMN requests to provide services with the Shared RAN. Each Frequency band in the list may be associated with the Geographical area so that the corresponding PLMN can request Frequency band per location basis. This information may form at least one from the followings:
         ARFCN (including EARFCN and NR-ARFCN)
      Tracking Area Code (TAC) list: TAC list to be assigned for RAN sharing. Each TAC in the list may be associated with the Geographical area and/or Frequency band so that the corresponding PLMN can assign TAC per location and/or Frequency band basis.

The Proxy AMF 7001 finds target RANs 5a based on the received Geographical area and/or Frequency band list from the AMF 7002. For example, if Geographical area indicates Urban centre of Tokyo, Frequency band list indicates NR-ARFCN as 2140 MHz for downlink and 1950 MHz for uplink, The Proxy AMF 7001 performs the step 2 for all or some shard RANs 5 that covers Urban centre of Tokyo with the Frequency band 2140 MHz for downlink and 1950 MHz for uplink. The Proxy AMF 7001 designates the received TAC to the RANs 5 that is associated to the Urban centre of Tokyo with the Frequency band 2140 MHz for downlink and 1950 MHz for uplink.
Step 2. The Proxy AMF 7001 configures the Shared RANs based on the received information in the Namf_Communication_NonUeN2InfoSubscribe message in Step 1. Shared RANs to be configured can be one or multiple Shared RANs depending on the received information in the Namf_Communication_NonUeN2InfoSubscribe message in Step 1. The details of this step are disclosed in the Fourth example of the First Aspect.
Step 3. After completion of configuration setup at the Step 2, the Proxy AMF 7001 sends the Namf_Communication_NonUeN2InfoSubscribe response message to the AMF 7002 including Configured Supported TA list and RAN Routing information list. The configured Supported TA list includes the received Supported TA list from the Shared RANs (For example, Shared RAN 501 and Shared RAN 502 in this example.).

For example, some designated area and/or some designated Frequency band may not be provided by the Shared RANs 5 due to local configuration in the Proxy AMF 7001, limited resources in the Proxy AMF 7001, limited configuration in the Shared RANs 5, or limited radio resources in the Shared RANs 5.

The Proxy AMF 7001 screens and configures the Configured Supported TA list from all received Supported TA list from the Shared RANs as some received Supported TA list may not be relevant to the AMF 7002. The RAN Routing information list is a list of routing address for associated Shared RANs. The RAN Routing information is used only when the AMF 7002 sends the NGAP message directly to the Shared RAN 501. The RAN Routing information is obtained by the Proxy AMF 7001 during the NGAP setup procedure with the Shared RAN 501.
Step 4. After the AMF 7002 has successfully subscribed to the Proxy AMF 7001, the Proxy AMF 7001 may send the Namf_Communication_NonUeN2InfoNotify message to the AMF 7002 to notify an event if a predefined event happens. The following list indicates possible events.
   N2 management message is received with regard to the AMF 7002.
   N2 UE related message is received for the UEs which have a 5G-GUTI assigned by the AMF 7002.

In one example, the AMF 7002 recognizes that the AMF 7002 has successfully subscribed to the Proxy AMF 7001 if the AMF 7002 receives a message in response to the Namf_Communication_NonUeN2InfoSubscribe response message.

In another example, the AMF 7002 recognizes that some requested Geographical area and/or Frequency band list cannot be configured in the Shared RAN 5 by receiving a Un-configured Supported TA List parameter in the Namf_Communication_NonUeN2InfoSubscribe response message in step 3. The Un-configured Supported TA List parameter includes all Geographical area and/or Frequency band list that has not configured in the Shared RAN 5.

Alternatively, the AMF 7002 recognizes that some requested Geographical area and/or Frequency band list cannot be configured by comparing contents in the Requesting PLMN support list in Namf_Communication_NonUeN2InfoSubscribe message in step 1 and contents in the Configured Supported TA list in Namf_Communication_NonUeN2InfoSubscribe response message in step 3.

As an example, PLMN 1 is provided by 5G operator and PLMN 2 is provided by 4G operator. The functionalities, disclosed in First Aspect, enable PLMN 2 to provide 5G service without direct link between shared RAN 5 and AMF 7002.

### Variant 1 of Second Example of the First Aspect

In step 1 of FIG. 4, the AMF 7002 may send multiple Namf_Communication_NonUeN2InfoSubscribe message to some Proxy AMFs in the PLMN 1 for resiliency purpose. For example, the AMF 7002 may subscribe to the Proxy AMF 7001a and the Proxy AMF 7001b in the PLMN 1. In this case, the AMF 7002 can communicate with the Shared RAN 501 via the Proxy AMF 7001b when the Proxy AMF 7001a fails. The AMF 7002 can communicate with the Shared RAN 501 via the Proxy AMF 7001a when the Proxy AMF 7001b fails. The Shared RAN 501 performs the Proxy AMF selection if the Shared RAN 501 has multiple Proxy AMFs associated with the AMF 7002. For example, the Shared RAN 501 performs the Proxy AMF selection based on a certain information (e.g., the associated priority, a certain comparison result).

### Variant 2 of Second Example of the First Aspect

In one example, it is possible that a certain PLMN is proxy capable only in specific geographic areas and/or in specific times. This means that the proxy AMF of such PLMN would not be able to provide proxy connection to the shared RAN for all RAN sharing PLMNs everywhere and at all the times. That is why it is proposed that the role of the proxy AMF and proxy PLMN is interchangeable with the location and with the time, i.e. different sharing proxy capable PLMN/AMF take the proxy responsibility with the change of the location and the time. For this it is proposed that in step 1 of FIG. 4, for the RAN sharing PLMN 2 and PLMN 3, the AMF 7002 and AMF 7003 include their ‘proxy capability information’ in the Namf_Communication_NonUeN2InfoSubscribe message to the proxy AMF 7001 and this capability information per RAN sharing PLMN is configured in the Shared RAN 5 in step 2. The proxy capability information parameter (or any other notation for a parameter to indicate where and when a RAN sharing AMF/PLMN is proxy capable) may contain the following information:
Proxy capability location—a location in terms of TAs or Geographical area where the RAN sharing AMF/PLMN can provide proxy connection to other RAN sharing AMFs/PLMNs, e.g. AMF 7002 of PLMN 1 and AMF 7003 of PLMN 3 with the Shared RAN, e.g. Shared RAN 5;
Proxy capability time—a time interval in terms of hours of the day or days of the week and etc—when the RAN sharing AMF/PLMN can provide proxy connection for the other RAN sharing PLMNs, e.g., AMF 7002 of PLMN 1 and AMF 7003 of PLMN 3 with the Shared RAN, e.g. Shared RAN 5;
Proxy capability validity—If a RAN sharing PLMN is granted with proxy capability for a specific time only (e.g. to facilitate public events and gatherings like meetings, conferences, sport events and etc), then the proxy capability may be valid for certain time defined with the proxy capability validity parameter;
Proxy capability restrictions—there may be other restriction policies related to the proxy capability of a RAN shared PLMN related to specific UEs or type of UEs or group of UEs in which case these restriction policies would be indicated within the proxy capability restriction parameters.

### Variant 3 of Second Example of the First Aspect

The Namf_Communication_NonUeN2InfoSubscribe/Namf_Communication_NonUeN2InfoSubscribe response/Namf_Communication_NonUeN2InfoNotify messages in Step 1, 3 and 4 respectively in FIG. 4 can be another AMF service name.

For example, Namf_Communication_N1N2MessageSubscribe/Namf_Communication_N1N2MessageSubscribe response/Namf_Communication_N1N2MessageTransfer messages or Namf_Communication_N2InfoSubscribe/Namf_Communication_N2InfoSubscribe response/Namf_Communication_N2InfoNotify messages or Namf_Communication_AMFStatusChangeSubscribe/Namf_Communication_AMFStatusChangeSubscribe/Namf_Communication_AMFStatusChangeNotify messages.

### Variant 4 of Second Example of the First Aspect

When the AMF 7002 terminates services with Shared RANs via the Proxy AMF 7001, the AMF 7002 sends the Namf_Communication_NonUeN2InfoUnSubscribe message to the Proxy AMF 7001 and terminates services with Shared RANs via the Proxy AMF 7001. The AMF 7002 performs the Namf_Communication_NonUeN2InfoUnSubscribe service with all associated Proxy AMFs 7001 in the PLMN 1.

Similarly, if the PLMN 2 terminates services with Shared RANs via the PLMN 1. All AMFs 7002 that associates with Proxy AMFs 7001 in the PLMN 1 send the Namf_Communication_NonUeN2InfoUnSubscribe message to all associated Proxy AMFs 7001 in the PLMN 1.

### Third Example of the First Aspect

This example discloses a procedure for communicating between the Shared RAN 501 and the AMF 7002.

After the procedure for connecting AMF and the Shared RANs via the Proxy AMF has successfully completed according to the Second example of the First Aspect, the AMF 7002 and the Shared RANs (the Shared RAN 501 and the Shared RAN 502 in this example) can communicate either via the Proxy AMF 7001 or directly.

FIG. 5 illustrates an example for NGAP message transfer from the Shared RAN 501 to the AMF 7002 when the UE 3, who has the 5G-GUTI assigned by the AMF 7002, sends an NAS message to the AMF 7002.

The detailed processes of NGAP message transfer from Shared RAN to AMF in Third example of the First Aspect are described below with reference to FIG. 5.
Step 0. The procedure for connecting AMF 7002 and the Shared RAN 501 via the Proxy AMF has successfully completed according to the Second example of the First Aspect.
Steps 1 to 3, The UE 3 establishes the RRC connection in order to send an NAS message to the AMF 7002. I.e. The RRC Setup Complete message in Step 3 includes the SelectedPLMN-Identity set to the PLMN 2.
In Step 4, the Shared RAN 501 decides either Indirect forwarding or Direct forwarding to take for forwarding NGAP message to the AMF 7002.

This decision can be made by local configuration or based on whether the Shared RAN 501 holds the routing information to the AMF 7002.

If the Indirect forwarding is chosen, Steps 4a and 5a take place.

If the Direct forwarding is chosen, Step 4b takes place.
Step 4a. Upon reception of the RRC Setup Complete message in Step 3, the Shared RAN 501 sends the Initial UE message to the Proxy AMF 7001 including 5G-S-TMSI, AMF Set ID, NAS-PDU and Selected PLMN Identity. The 5G-S-TMSI indicates a temporary user ID for UE 3. The AMF Set ID indicates the AMF identity of the AMF 7002. The NAS-PDU is a container that contains the NAS message that is sent from the UE 3. The Selected PLMN Identity indicates the PLMN identity of the PLMN 2.

The shared RAN 501 creates a UE context with user identity set to 5G-GUTI as received during the RRC connection setup procedure.
Step 5a. Upon reception of the Initial UE message in Step 4a, the Proxy AMF 7001 finds the AMF 7002 as the destination of the NGAP message transfer based on the received AMF Set ID and the Selected PLMN Identity. The Proxy AMF 7001 sends the Namf_Communication_NonUeN2InfoNotify message to the AMF 7002 including User ID and the NGAP message container. The User ID indicates the identity of the UE 3. The NGAP message container contains the NGAP message that is received in Step 4a. In one example the user identity is set to 5G-GUTI as constructed in the step 4a above.
   When the AMF 7002 receives the Namf_Communication_NonUeN2InfoNotify message, the AMF 7002 treats the content of the NGAP message container as an NGAP message that is received from the Shared RAN 501 over the N2 reference point. The AMF 7002 creates the UE context with one of primary identity is set to 5G-GUTI as received in the Namf_Communication_NonUeN2InfoNotify message.
Step 4b. Upon reception of the RRC Setup Complete message in Step 3, the Shared RAN 501 sends the Initial UE message to the AMF 7002 including 5G-S-TMSI, AMF Set ID and NAS-PDU.

FIG. 6 illustrates an example for NGAP message transfer from the AMF 7002 to Shared RAN 501.

The detailed processes of NGAP message transfer from AMF to Shared RAN in Third example of the First Aspect are described below with reference to FIG. 6.
Step 0. The procedure for connecting AMF 7002 and the Shared RAN 501 via the Proxy AMF has successfully completed according to the Second example of the First Aspect.
In Step 1, the AMF 7002 decides either Indirect forwarding or Direct forwarding to take for forwarding NGAP message to the Shared RAN 501.

This decision can be made by local configuration or based on whether the AMF 7002 holds the routing information to the Shared RAN 501.

If the Indirect forwarding is chosen, Steps 1a and 2a take place.

If the Direct forwarding is chosen, Step 1b takes place.
Step 1a. The AMF 7002 sends the Namf_Communication_NonUeN2Message Transfer message to the Proxy AMF 7001 including User ID and NGAP message container. The User ID indicates the identity of the UE 3. The user identity is the 5G-GUTI as received in the step 5a of third example of the first aspect. The NGAP message container contains the NGAP message that needs to be sent to the Shared RAN 501 via the Proxy AMF 7001.
Step 2a. Upon reception of the Namf_Communication_NonUeN2MessageTransfer message in Step 1a, the Proxy AMF 7001 finds that the Shared RAN 501 is the destination of the NGAP message based on the NGAP message in the NGAP message container. The Proxy AMF 7001 sends a NGAP message to the Shared RAN 501 by extracting the NGAP message from the NGAP message container. In one example the user identity (e.g. User ID) received in the Namf_Communication_NonUeN2MessageTransfer message is used to find the UE context in the proxy AMF 7001. In one example, the AMF 7001 includes the user identity of the UE in the NGAP message. The shared RAN uses the user identity to find the UE context. The shared RAN further processes the NGAP message container.
   In another example, if the NGAP message container contains the PAGING message, the Proxy AMF 7001 performs the page procedure with multiple cells based on the TAI List for Paging information element in the PAGING message.

Similarly, if the NGAP message container contains the MULTICAST GROUP PAGING message, the Proxy AMF 7001 performs the group page procedure with multiple cells based on the Multicast Group Paging Area List information element in the MULTICAST GROUP PAGING message.

Similarly, if the NGAP message container contains the WRITE-REPLACE WARNING REQUEST message, the Proxy AMF 7001 performs the group page procedure with multiple cells based on the Warning Area List information element in the WRITE-REPLACE WARNING REQUEST message.
Step 1b. The AMF 7001 sends the NGAP message directly to the Shared RAN 501.

### Variant 1 of Third Example of the First Aspect

The Namf_Communication_NonUeN2InfoNotify message in step 5a in FIG. 5 can be another AMF service name. For example, Namf_Communication_NonUeN2Message Transfer, Namf_Communication_N1N2MessageTransfer or Namf_Communication_N2InfoNotify message.

### Variant 2 of Third Example of the First Aspect

The Namf_Communication_NonUeN2MessageTransfer message in step 1a in FIG. 6 can be another AMF service name. For example, Namf_Communication_NonUeN2InfoNotify, Namf_Communication_N1N2MessageTransfer or Namf_Communication_N2InfoNotify message.

### Variant 3 of Third Example of the First Aspect

In case where the Shared RANs are connected with multiple Proxy AMFs 7001 and the NAS-PDU in steps 4a and 5a or step 4b in FIG. 5 is the Registration Request message, the AMF 7002 may configure and send the Tracking Area list to the UE 3 that are within the area that the Proxy AMF 7001 covers.

Alternatively, the AMF 7002 may configure and send the Tracking Area list to the UE 3 that spans to multiple Proxy AMFs 7001. In this case, the AMF 7002 sends multiple Namf_Communication_NonUeN2MessageTransfer messages that contains the paging message in Step 1a in FIG. 6 to all Proxy AMFs 7001 that covers the whole Registration area (i.e. the Registration area is equal to the area that all tracking areas in the Tracking area list cover.) of the UE 3. In this case, the TAI List for Paging information in each paging message encapsulated in the NonUeN2MessageTransfer message should contains only TAIs that cells connected to each Proxy AMF 7001 covers. When the AMF 7002 receives the Service Request message from one Proxy AMF 7001 as the page response, the AMF 7002 may send to another Proxy AMFs 7001 the NonUeN2MessageTransfer message including the Page Stop message for stopping paging procedure.

### Variant 4 of Third Example of the First Aspect

The NGAP signaling message in step 4a in FIG. 5 may be named as INITIAL UL UE SIGNALING TRANSFER message that contains the RAN UE NGAP ID and NGAP message container. This NGAP message container contains the Initial UE message generated by the Shared RAN 501. This Initial UE message is transparent to the Proxy AMF 7001. The RAN UE NGAP ID identifies the UE association over the NG interface within the NG-RAN node.

The NGAP signaling message in Step 2a in FIG. 6 may be named as DL UE SIGNALING TRANSFER message that contains the AMF UE NGAP ID which is allocated by the Proxy AMF 7001, and NGAP message container. This NGAP message container contains the NGAP message that is generated by the AMF 7002. This NGAP message is transparent to the Proxy AMF 7001.

The RAN UE NGAP ID and the AMF UE NGAP ID are used to create a logical connection associated to a UE over NG interface as specified in section 6.2.1 in 3GPP TS 38.401 (NPL 13). In this case, the logical connection associated with the UE is between the Shared RAN 501 and the Proxy AMF 7001. There is another logical connection associated with the UE between Shared RAN 501 and AMF 7002.

Alternatively, instead of using the RAN UE NGAP ID and the AMF UE NGAP ID, the User ID may be allocated by Shared RAN 501. This User ID is included in the INITIAL UL UE SIGNALING TRANSFER message to be sent from Shared RAN 501 to Proxy AMF 7001. The Proxy AMF 7001 uses this User ID to associate the UE related signaling between Shared RAN 501 and AMF 7002.

While not shown in the figure, the UE signaling message after the INITIAL UL UE SIGNALING TRANSFER message, sent from Shared RAN 501 to the Proxy AMF 7001 may be named as UL UE SIGNALING TRANSFER message. This UL UE SIGNALING TRANSFER message contains e.g. RAN UE NGAP ID and the AMF UE NGAP ID (or User ID) to identify the logical connection associated with the UE, and NGAP message which is transparent to the Proxy AMF 7001. The Proxy AMF 7001 find the AMF 7002 from the logical connection associated with the UE 3.

### Variant 5 of Third Example of the First Aspect

After Step 4a in FIG. 5, the Proxy AMF 7001 forwards any NGAP message received from the Shared RAN 501 to the AMF 7002 based on contents in the Received NGAP message. For example, the Proxy AMF 7001 find the AMF 7002 based on a received RAN UE NGAP ID in the NGAP message from the Shared RAN 501. The Proxy AMF 7001 finds a User ID on the Namf_Communication_NonUeN2InfoNotify message based on the received RAN UE NGAP ID as the Proxy AMF 7001 associates the received RAN UE NGAP ID and User ID during the Initial Context Setup procedure as described in NPL 7.

### Variant 6 of Third Example of the First Aspect

When the Proxy AMF 7001 receives the NGAP message in Step 4a in FIG. 5 and the Proxy AMF 7001 cannot find the associated AMF 7002, The Proxy AMF 7001 simply discards the received NGAP message. This may happen after the AMF 7002 has been unsubscribed from the AMF service that the Proxy AMF provides.

### Fourth Example of the First Aspect

This example discloses the capability negotiation and configuration setup between the Shared RAN 501 and the Proxy AMF 7001. This procedure also takes place between the Shared RAN 502 and the Proxy AMF 7001.

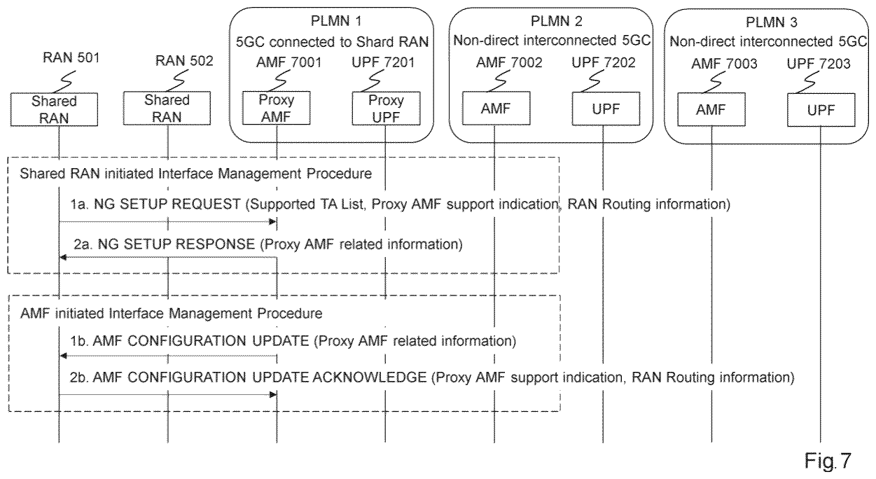

The detailed processes of the Fourth example of the First Aspect are described below with reference to FIG. 7, which illustrates the capability negotiation and configuration setup between the Shared RAN and the Proxy AMF.
Steps 1a and 2a illustrates the Shared RAN initiated Interface management procedure and these steps are independent from Steps 1b and 2b.
Step 1a. The Shared RAN 501 sends the NG SETUP REQUEST message to the Proxy AMF 7001 including Supported TA List, Proxy AMF support indication and RAN Routing information. The Supported TA List indicates supported TAs in the Shared RAN 5 that may include TAs for the PLMN 2 or/and PLMN 3. The Proxy AMF support indication indicates that the Shared RAN 501 supports the functionalities that are disclosed by the First Aspect. The Proxy AMF support indication can be a different expression or natation, for example Proxy AMF capable RAN, Dynamic shared RAN installation function and so on. The RAN Routing information indicates a routing information that can be used by the AMFs (AMF 7002 and AMF 7003 in this example) that are proxied by the Proxy AMF 7001. The RAN Routing information may take a form of FQDN or IP address or etc.

If the RAN Routing information is an IP address, the IP address may be IPv4 address or IPv6 address.
Step 2a. Upon reception of the NG SETUP REQUEST message in Step 1a, The Proxy AMF 7001 stores the Proxy AMF support indication that is received in Step 1a as a capability of Shared RAN 5 and sends the NG SETUP RESPONSE message to the Shared RAN 501 including Proxy AMF related information. The Proxy AMF related information includes information that is related to the Proxy AMF functions in order to perform interworking between the Shared RAN 501 and AMFs that are not directly connected to the Shared RAN 501. The Proxy AMF related information may include the following information.
   Proxy AMF capability: The Proxy AMF capability indicates its support of the Proxy AMF functionality. When the Shared RAN 501 receives this information, the Shared RAN 5 acknowledges that the Proxy AMF 7001 can act as the Proxy AMF.
   Proxied PLMN Support List: The Proxied PLMN Support List indicates a list of supported AMFs that may interwork with the Shared RAN 501. Each entry in the Proxied PLMN Support List may include the following information with regard to AMF:
      AMF routing information: The AMF Routing information indicates a routing information that can be used by the Shared RAN 501 when the Shared RAN 501 sends the NGAP message directly to the AMFs. (AMF 7002 and AMF 7003 in this example). The AMF Routing information may be represented with FQDN or IP address or etc. If the AMF Routing information is an IP address, the IP address may be IPv4 address or IPv6 address.
         Proxied PLMN Support Item: This is a list of supported PLMNs. Each entry in the PLMN Support Item may include the following information.
         Served GUAMI item: This is a list of AMF identity that are supported by the Proxy AMF 7001. Each entry in the Served GUAMI item may include PLMN Identity, Slice Support List, NPN Support, Extended Slice Support List, Onboarding Support as defined in NPL 7.
   Proxied Supported TA List: The Proxied Supported TA List indicates a list of supported Tracking Areas (i.e. TAs) that the Proxied AMF requests the Shared RAN 501 to configure. Each entry in the Proxied Supported TA List may include the following information as a request to configure in the Shared RAN 501. NPL 7 defines details of each information.
      TAC: Broadcast TAC.
      Broadcast PLMN item: See NPL 7 for details.
      Configured TAC Indication
      RAT Information

The Shared RAN 501 confirms and updates the radio configuration setting on whether it is compliant with the received Proxied Supported TA List in the NG SETUP RESPONSE message in Step 2a.
Steps 1b and 2b illustrates the AMF initiated Interface management procedure and these steps are independent from Steps 1a and 2a. In one example, this procedure is triggered when the Proxy AMF receives the Namf_Communication_NonUeN2InfoSubscribe message as disclosed by the Step 1 in FIG. 4.
Step 1b. The Proxy AMF 7001 sends the AMF CONFIGURATION UPDATE message including Proxy AMF related information. Refer to step 2a for details of the Proxy AMF related information.

The Shared RAN 501 confirms and updates the radio configuration setting on whether it is compliant with the received Proxied Supported TA List in the AMF CONFIGURATION UPDATE message in Step 1b.
Step 2b. The Shared RAN 501 sends the AMF CONFIGURATION UPDATE message to the Proxy AMF 7001 including Proxy AMF support indication and the RAN Routing information. Refer to step 2a for detail of the Proxy AMF support indication and the RAN Routing information.

For example, if the AMF CONFIGURATION UPDATE message including Proxy AMF related information with new PLMN (ex, PLMN 2) to be added, The Shared RAN 501 finds cells that needs to add new PLMN and instructs such cells to broadcast new PLMN setting according to the cellAccessRelatedInfo in SIB 1.

### Variant 1 of Fourth Example of the First Aspect

Step 1a can be replaced with the RAN CONFIGURATION UPDATE message. Similarly, Step 2a can be replaced with the RAN CONFIGURATION UPDATE ACKNOWLEDGE message.

### Variant 2 of Fourth Example of the First Aspect

For the AMF initiated Interface management procedure (Steps 1b and 2b), Steps 1b and 2b may have unique NGAP messages in case new PLMN or new AMF is added to the NGAP interface by the Proxy AMF 7001. In this case 1b/2b may be named as AMF add request/response, PLMN add request/response, AMF installation request/response, PLMN installation request/response or any other NGAP message name respectively.

### Fifth Example of the First Aspect

This example discloses the capability negotiation and configuration setup between the Shared RANs.

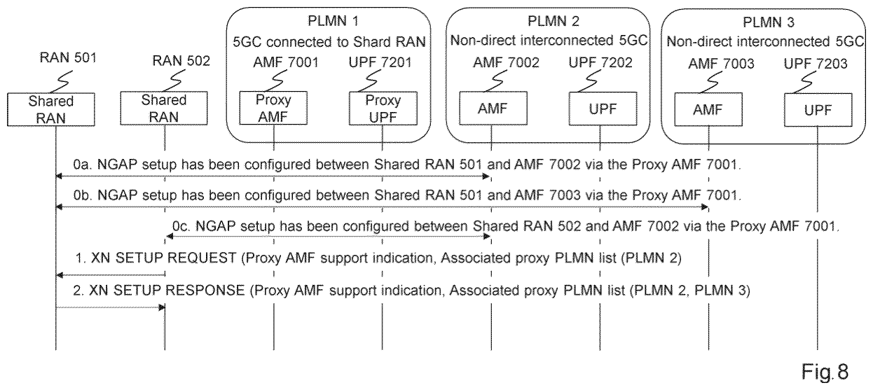

The detailed processes of the Fifth example of the First Aspect are described below, with reference to FIG. 8, which illustrates the capability negotiation and configuration setup between the Shared RANs.
Steps 0a, 0b and 0c are NGAP setup procedures that had taken place prior to the XN setup procedure between the Shared RAN 501 and the Shared RAN 502. In this example, the Shared RAN 501 is associated with the AMF 7002 in the PLMN 2 and the AMF 7003 in the PLMN 3 while the Shared RAN 502 is only associated with the AMF 7002 in the PLMN 2.

These NGAP setup procedures may take place based on the NGAP setup procedure as disclosed by the Fourth example of the First Aspect.
Step 1. The Shared RAN 502 sends the XN SETUP REQUEST message to the Shared RAN 501 including Proxy AMF support indication and Associated proxy PLMN list. Refer to Step 1a in FIG. 7 for the details of the Proxy AMF support indication. The Associated proxy PLMN list in Step 1 indicates a list of PLMNs that the Shared RAN 502 associates with. In this example, the Associated proxy PLMN list in Step 1 includes only PLMN 2 as the PLMN 2 is only associated PLMN based on the Step 0c.

In one example, the Proxy AMF support indication and Associated proxy PLMN list are used by the Shared RAN 501 when the Shared RAN 501 finds target cells for the Handover procedure. For example, if the Handover procedure to be initiated by the Shared RAN 501 for the UE 3 which is associated with the PLMN 3, the Shared RAN 501 should not select cells as the target cell for the Handover, if such cells belong to the Shared RAN 502 because the Handover procedure to such cells is most likely to fail as the Shared RAN 502 does not have an association with the PLMN 3.
Step 2. Upon reception of the XN SETUP REQUEST message from the Shared RAN 502, the Shared RAN 501 sends the XN SETUP RESPONSE message to the Shared RAN 502 including Proxy AMF support indication and Associated proxy PLMN list. Refer to Step 1a in FIG. 7 for the details of the Proxy AMF support indication. Refer to Step 1 for the details of the Associated proxy PLMN list. In this example, the Associated proxy PLMN list in Step 2 includes PLMN 2 and PLMN 3 as the PLMN 2 and PLMN 3 are associated PLMNs based on the Step 0a and Step 0b respectively.

In one example, the Shared RAN 501 sends the XN SETUP REQUEST message to the Shared RAN 502 including Proxy AMF support indication and Associated proxy PLMN list. In this example, the Associated proxy PLMN list, included in the XN SETUP REQUEST message, includes PLMN 2 and PLMN 3 and the Associated proxy PLMN list, included in the XN SETUP RESPONSE message, includes PLMN 2.

### Variant 1 of Fifth Example of the First Aspect

Step 1 can be replaced with the NG-RAN NODE CONFIGURATION UPDATE message. Similarly, Step 2 can be replaced with the NG-RAN NODE CONFIGURATION UPDATE ACKNOWLEDGE message.

### Sixth Example of the First Aspect

This example discloses the capability negotiation and configuration setup between the Proxy AMF, Proxy SMF and Proxy UPF.

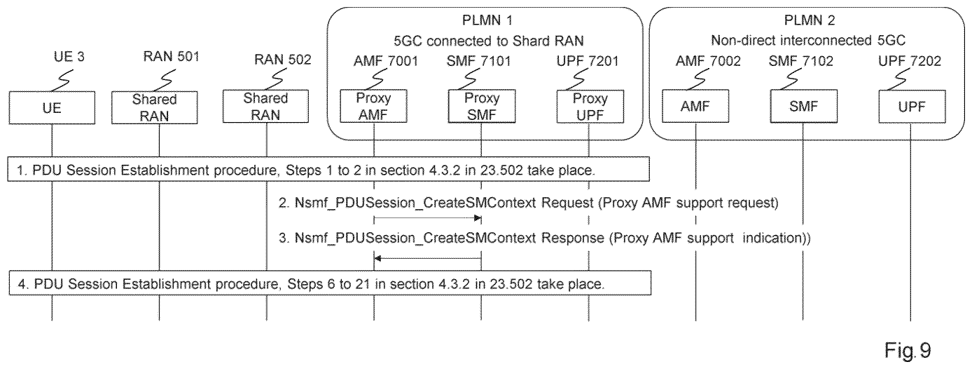

The detailed processes of the Sixth example of the First Aspect are described below, with reference to FIG. 9, which illustrates the capability negotiation and configuration setup in 5GC.
Step 1. The PDU Session Establishment procedure is triggered in accordance with the section 4.3.2 in NPL 4 and Steps step 1 and step 2 takes place.
Step 2. The Proxy AMF 7001 sends the Nsmf_PDUSession_CreateSMContext Request message to the Proxy SMF 7101 including Proxy AMF support request. The Proxy AMF support request indicates that the Proxy AMF procedure, as disclosed in the First Aspect, is needed and requests the Proxy SMF to support the Proxy AMF procedure. The Proxy AMF 7001 may include the Proxy AMF support request in case where the UE 3 has a 5G-GUTI in the PLMN 2. I.e. the Proxy AMF 7001 has to interwork with the AMF 7002 for the PLMN 2 for session management procedure.
Step 3. Upon reception of the Nsmf_PDUSession_CreateSMContext Request message with the Proxy AMF support request, The Proxy SMF 7101 selects the UPF 7201 where the UPF 7201 supports the Proxy AMF procedure as disclosed in the First Aspect. Once the Proxy SMF 7101 ensures that Proxy SMF 7101 together with the Proxy UPF 7201 can support the Proxy AMF procedure, The Proxy SMF 7101 sends the Nsmf_PDUSession_CreateSMContext Response message to the Proxy AMF 7001 including with the Proxy AMF support indication. The Proxy AMF support indication indicates that Both Proxy SMF 7101 and the Proxy UPF 7201 support the functionalities that are disclosed by the First Aspect.
Step 4. Steps 6 to 21 in the PDU Session Establishment procedure continues in accordance with the section 4.3.2 in NPL 4.

### Seventh Example of the First Aspect

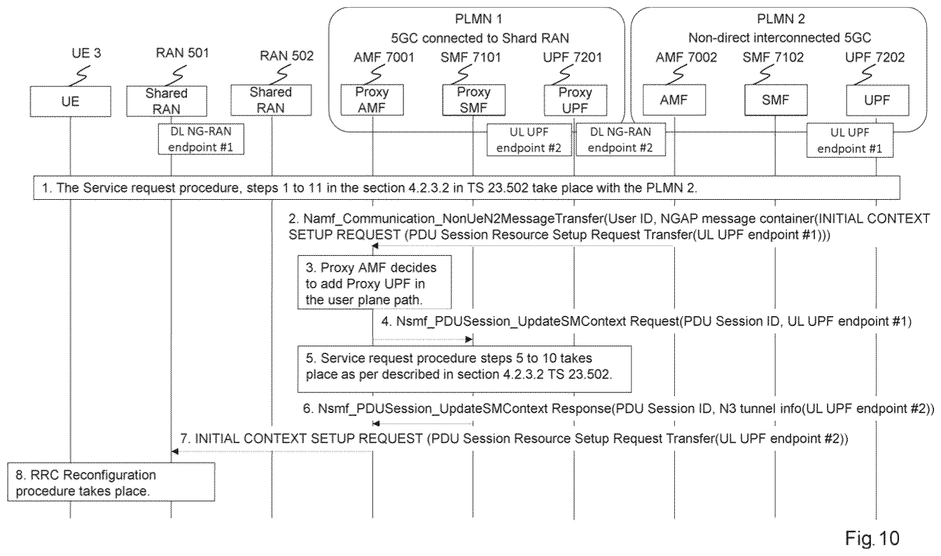

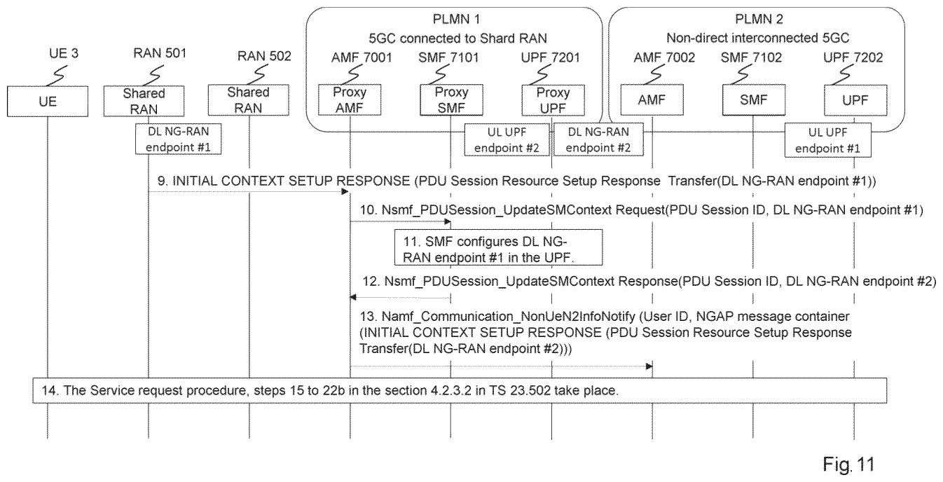

This example discloses the Service Request procedure with the Proxy AMF. The Service Request procedure is discloses using two figures, FIG. 10 and FIG. 11.

FIG. 10 illustrates the Service Request procedure with the Proxy AMF (First part). The first part of detailed processes of the Seventh example of the First Aspect are described below, with reference to FIG. 10.
Step 1. The Service request procedure with the Shard RAN 501 is initiated by the UE 3 in accordance with the section 4.2.3.2 in NPL 4 and steps 1 to step 11 take place. As the UE 3 holds the 5G-GUTI that is assigned by the AMF 7002, the Proxy AMF 7001 behaves as the Proxy AMF as disclosed in the Second example of the First Aspect.

Note that the UE 3 holds the 5G-GUTI assigned by the AMF 7002 after the successful Registration procedure with the AMF 7002 as described in NTP 4. The Registration procedure can be performed using the procedures in FIG. 5 and FIG. 6 as disclosed in the third example of the First Aspect.
Step 2. The AMF 7002 sends the Namf_Communication_NonUeN2MessageTransfer message to the Proxy AMF 7001 including User ID and NGAP message container. The NGAP message container contains INITIAL CONTEXT SETUP REQUEST message. Further, the INITIAL CONTEXT SETUP REQUEST message contains the PDU Session Resource Setup Request Transfer with UL UPF endpoint #1.
Step 3. The Proxy AMF 7001 decides to add the Proxy UPF 7201 in the user plane path between the Shared RAN 501 and the UPF 7202.
Step 4. The Proxy AMF 7001 sends the Nsmf_PDUSession_UpdateSMContext Request message to the Proxy SMF 7101 including PDU Session ID, UL UPF endpoint #1.
Step 5. The Service request procedure continues with step 5 to step 10 in accordance with the section 4.2.3.2 in NPL 4. In this procedure, the Proxy SMF 7101 informs the UL UPF endpoint #1 to the Proxy UPF 7201 as the destination of the Uplink packet if the Proxy UPF 701 receives the user plane packet from the Shared RAN 501.
Step 6. The Proxy SMF 7101 sends the Nsmf_PDUSession_UpdateSMContext Response message to the Proxy AMF 7001 including the PDU Session ID, N3 tunnel info with UL UPF endpoint #2.
Step 7. Upon reception of the Nsmf_PDUSession_UpdateSMContext Response message, The Proxy AMF 7001 sends the INITIAL CONTEXT SETUP REQUEST message to the Shared RAN 501 including the PDU Session Resource Setup Request Transfer with UL UPF endpoint #2.
Step 8. The RRC Reconfiguration Procedure takes place.

The second part of detailed processes of the Sixth example of the First Aspect is described below with reference to FIG. 11, which illustrates the Service Request procedure with the Proxy AMF (Second part). The step 9 in FIG. 11 is a continuation of the Step 8 in FIG. 10.
Step 9. The Shared RAN 501 sends the INITIAL CONTEXT SETUP RESPONSE message to the Proxy AMF 7001 including PDU Session Resource Setup Response Transfer with DL NG-RAN endpoint #1.
Step 10, As the Proxy AMF 7001 recognizes that the UPF 7201 is about to be inserted between the Shared RAN 501 and The UPF 7201, The Proxy AMF 7001 sends the Nsmf_PDUSession_UpdateSMContext Request message to the Proxy SMF 7101 including PDU Session ID and DL NG-RAN endpoint #1.
Step 11. The Proxy SMF informs the DL NG-RAN endpoint #1 to the Proxy UPF 7201 as the destination of the Downlink packet if the Proxy UPF 701 receives the user plane packet from the UPF 7202.
Step 12. The Proxy SMF 7101 sends the Nsmf_PDUSession_UpdateSMContext Response message to the Proxy AMF 7001 including PDU Session ID and DL NG-RAN endpoint #2.
Step 13. Upon reception of the Nsmf_PDUSession_UpdateSMContext Response message, the Proxy AMF 7001 sends Namf_Communication_NonUeN2InfoNotify message to the AMF 7002 including User ID and NGAP message container. The NGAP message container contains the INITIAL CONTEXT SETUP RESPONSE message. Further, the INITIAL CONTEXT SETUP RESPONSE message contains PDU Session Resource Setup Response Transfer with DL NG-RAN endpoint #2.
Step 14. Steps 15 to 6 to 22b in the Service request procedure continues in accordance with the section 4.2.3.2 in NPL 4.

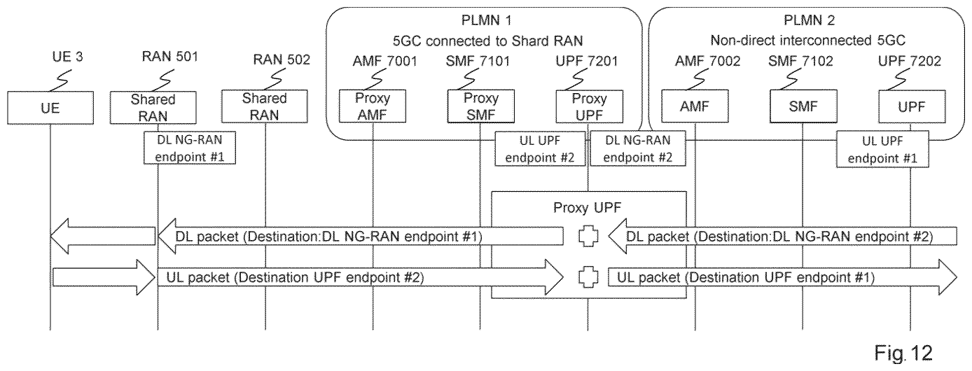

After completion of the Service request procedure with the Proxy AMF, the following user plane path is established. The Proxy UPF 7201 behaves as a relay node for both DL packets and UP packets between the Shared RAN 501 and the UPF 7202. FIG. 12 illustrates how the UP packets and DL packets are relayed by the Proxy UPF 7201.

### Variant 1 of Seventh Example of the First Aspect

The Namf_Communication_NonUeN2MessageTransfer message in step 2 in FIG. 10 can be another AMF service name. For example, Namf_Communication_NonUeN2InfoNotify, Namf_Communication_N1N2MessageTransfer or Namf_Communication_N2InfoNotify message.

### Variant 2 of Seventh Example of the First Aspect

The Namf_Communication_NonUeN2InfoNotify message in step 13 in FIG. 11 can be another AMF service name. For example, Namf_Communication_NonUeN2MessageTransfer, Namf_Communication_N1N2MessageTransfer or Namf_Communication_N2InfoNotify message.

### Eighth Example of the First Aspect

This example discloses a TAC broadcasting by the shared RAN 5 connected to the Proxy AMF 7001 and also indirectly connected via the Proxy AMF 7001 to the AMF 7002. The network architecture is assumed as the same as FIG. 1 in the First example of the First Aspect. However, it is not excluding any other possible network architectures to be applied.

The shared RAN 5 may be shared by multiple operators (or PLMNs) with respect to a RAN node equipment, where a cell (or cells) operated by each operator (or PLMN) is independent each other. This is considered as a type 1 sharing. Alternatively, the shared RAN 5 may be shared by multiple operators (or PLMNs) with respect to a spectrum, where a cell (or cells) operated by one operator (or PLMN) is shared by more than one other operator (or PLMN). This is considered as a type 2 sharing. The shared RAN 5 connected to the Proxy AMF 7001 can broadcast a TAC (or TACs) depending on the type of sharing the RAN node.

### Variant 1 of Eighth Example of the First Aspect

The shared RAN 5 is used by the type 1 sharing. The shared RAN 5 is shared by the PLMN 1 and the PLMN 2. The RRC layer of the shared RAN 5 transmits the SIB1 (System Information Block type 1) message including one TAC per cell.

### Variant 2 of Eighth Example of the First Aspect

The shared RAN 5 is used by the type 2 sharing. The shared RAN 5 is shared by the PLMN 1 and the PLMN 2. The RRC layer of the shared RAN 5 transmits the SIB1 message including two TACs per cell. One TAC corresponds to the PLMN 1 and the other TAC corresponds to the PLMN 2.

### Ninth Example of the First Aspect

This example discloses a procedure for communicating between the Shared RAN 502 and the AMF 7002.

After the procedure for connecting AMF and the Shared RANs via the Proxy AMF has successfully completed according to the Second example of the First Aspect, the AMF 7002 and the Shared RANs (the Shared RAN 501 and the Shared RAN 502 in this example) can communicate either via the Proxy AMF 7001 or directly.

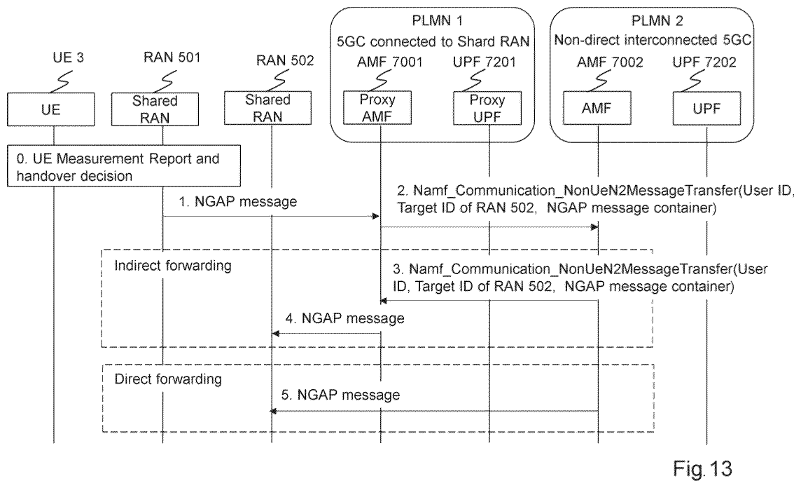

FIG. 13 illustrates an example for NGAP message transfer from the AMF 7002 to the Shared RAN 502 when the Shared RAN 501 decided to handover the UE 3 to the target shared RAN 502, via the AMF, which is also called NG Handover.

In an example, the Shared RAN 501 decides to handover the UE 3 to the target shared RAN 502 via the AMF 7002.
Step 0. The UE 3 send Measurement Report message to the Shared RAN 501, the Shared RAN 501 decided to handover the UE to the Shared RAN 502 via the AMF. The decision of the handover via AMF can be for example when there is no direct interface or direct connection between Shared RAN 501 and Shared RAN 502.
Step 1. The Shared RAN 501 sends the NGAP message to the Proxy AMF 7001. This NGAP message may be HANDOVER REQUIRED message.
Step 2. The Proxy AMF 7001 sends the Namf_Communication_NonUeN2Message Transfer message to the AMF 7002 including User ID, Target ID of RAN 502 and NGAP message container. The User ID indicates the identity of the UE 3. The Target ID of RAN 502 indicates the target RAN 502 to be handover to. The NGAP message container contains the NGAP message that is received in Step 1.

If Indirect forwarding is chosen, steps 3 and 4 take place.

If Direct forwarding is chosen, step 5 takes place.
Step 3. Upon reception of the Namf_Communication_NonUeN2MessageTransfer message in Step 2, the AMF 7002 realizes that the received NGAP message container contains the HANDOVER REQUIRED message for handover the UE 3 to the target Shared RAN 502, indicated by the Target ID of RAN 502. The AMF 7002 sends a Namf_Communication_NonUeN2MessageTransfer message to the Proxy AMF 7001 including the User ID, Target ID of the RAN 502 and NGAP message container. In one example, the NGAP message container includes HANDOVER REQUEST message.
Step 4. The Proxy AMF 7001 sends a NGAP message to the Shared RAN 502 by extracting the NGAP message from the NGAP message container. In one example, the Proxy AMF 7001 find the Shared RAN 502 by the Target ID of RAN 502 received in the Namf_Communication_NonUeN2MessageTransfer message from the AMF 7002.
   In one example the user identity received in the Namf_Communication_NonUeN2MessageTransfer message is to relate the UE context with the Shared RAN 502.

In another example, the Proxy AMF 7001 includes the user identity of the UE in the NGAP message send to Shared RAN 502. The shared RAN 502 uses the user identity to create a new UE context. The shared RAN further processes the NGAP message container. In one example, the NGAP message container contains HANDOVER REQUEST message.
Step 5. The AMF 7002 sends the NGAP message directly to the Shared RAN 502.

### Variant 1 of Ninth Example of the First Aspect

The signaling message in step 4 in FIG. 13 may be named as INITIAL DL UE SIGNALING TRANSFER message that contains the AMF UE NGAP ID and NGAP message container. This NGAP message container contains the HANDOVER REQUEST message generated by the AMF 7002, this HANDOVER REQUEST is transparent to the Proxy AMF 7001.

When received NGAP message in step 4 in FIG. 13, the Shared RAN 502 may allocate its RAN UE NGAP ID.

The RAN UE NGAP ID and the received AMF UE NGAP ID are used to create a logical connection associated to a UE over NG interface as specified in section 6.2.1 in NPR 13. In this case, the logical connection associated to the UE is between Shared RAN 502 and Proxy AMF 7001. There is another logical connection associated to the UE between Shared RAN 502 and AMF 7002.

While not shown in FIG. 13, after step 4, the Shared RAN 502 may send NGAP message e. g. named as UL UE SIGNALING TRANSFER message to the Proxy AMF 7001. This UL UE SIGNALING TRANSFER message contains e.g. RAN UE NGAP ID and the AMF UE NGAP ID (or User ID) to identify the logical connection associated to the UE, and NGAP Message Container contains a NGAP message which is transparent to the Proxy AMF 7001. This NGAP message may be HANDOVER REQUEST ACKNOWLEDGE. The Proxy AMF 7001 find the AMF 7002 from the logical connection associated to the UE 3.

### Tenth Example of the First Aspect

This example discloses a procedure for communicating between the Shared RAN 501 and Shared 502 and the AMF 7002.

After the procedure for connecting AMF and the Shared RANs via the Proxy AMF has successfully completed according to the Second example of the First Aspect, the AMF 7002 and the Shared RANs (the Shared RAN 501 and the Shared RAN 502 in this example) can communicate either via the Proxy AMF 7001 or directly.

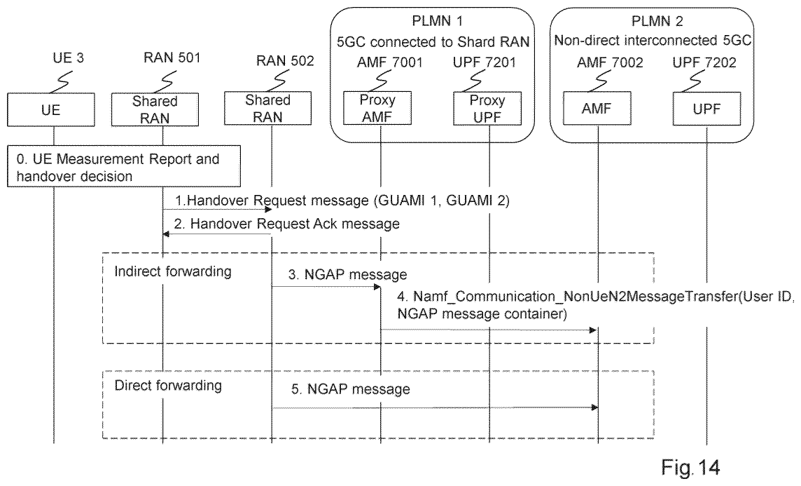

FIG. 14 illustrates an example for Xn handover signalling procedure.
Step 0. The UE 3 send Measurement Report message to the Shared RAN 501, the Shared RAN 501 decided to handover the UE to the Shared RAN 502 directly via Xn interface.
Step 1. The Shared RAN 501 sends the Xn Handover Request message to the Shared RAN 502. This Handover Request message may contain GUAMI 1 and GUAMI 2. The GUAMI 1 may indicate the AMF Identity of Proxy AMF 7001, the GUAMI 2 may indicate the AMF Identity of AMF 7002. Alternatively, the GUAMI 1 may indicate the AMF Identity of AMF 7002, the GUAMI 2 may indicate the AMF Identity of Proxy AMF 7001.

In this case, the Shared RAN 501 may be called source RAN node, the Shared RAN 502 may be called target RAN node.
Step 2, The Shared RAN 502 sends the Xn Handover Request Ack message to the Shared RAN 501.

If Indirect forwarding is chosen, steps 3 and 4 take place.

If Direct forwarding is chosen, step 5 takes place.
Step 3. The Shared RAN 502 identify the Proxy AMF 7001 by the GUAMI 1 or GUAMI 2 that is received in step 1, and sends the NGAP message to the Proxy AMF 7001. This NGAP message may be Path Switch Request message.
Step 4. The Proxy AMF 7001 sends the Namf_Communication_NonUeN2Message Transfer message to the AMF 7002 including User ID, and NGAP message container. The User ID indicates the identity of the UE 3. The NGAP message container contains the NGAP message that is received in Step 3.
Step 5. The AMF 7002 sends the NGAP message directly to the Shared RAN 502.

### Variant 1 of Tenth Example of the First Aspect

The signaling message in step 3 in FIG. 14 may be named as INITIAL UL UE SIGNALING TRANSFER From Target RAN message that contains the RAN UE NGAP ID, Source AMF UE NGAP ID and NGAP message container. This NGAP message container contains the PATH SWITCH REQUEST message generated by Shared RAN 502, this PATH SWITCH REQUEST message is transparent to the Proxy AMF 7001.

When received NGAP message in step 3 in FIG. 14, the Proxy AMF 7001 may find the UE context by the received Source AMF UE NGAP ID, then associate the received RAN UE NGAP ID with the UE Context.

The RAN UE NGAP ID and the received AMF UE NGAP ID are used to create a logical connection associated to a UE over NG interface as specified in section 6.2.1 in NPL 13. In this case, the logical connection associated to the UE is between Shared RAN 502 and Proxy AMF 7001. There is another logical connection associated to the UE between Shared RAN 502 and AMF 7002.

While not show in FIG. 14, after the step 4, the AMF 7002 may send Namf_Communication_NonUeN2MessageTransfer message to the Proxy AMF 7001 including User ID and NGAP message container. The User ID indicates the identity of the UE 3. The NGAP message container contains the NGAP message e.g. Path Switch Request Acknowledge message. The Proxy AMF 7001 sends a NGAP message to the Shared RAN 502 by extracting the NGAP message from the NGAP message container. Alternatively, the NGAP message send to the Shared RAN 502 may be named as DL UE SIGNALING TRANSFER message.

### System Overview

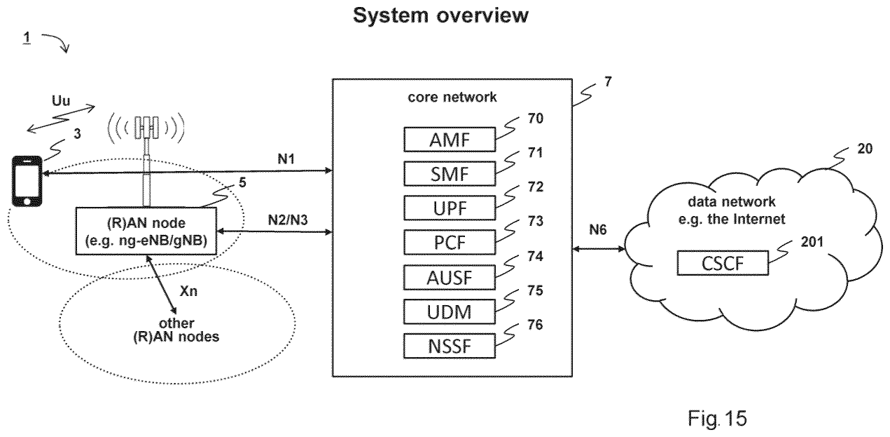

FIG. 15 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (I.EEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type. The data network may include an AAA 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI. Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI.EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message. PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### User Equipment (UE)

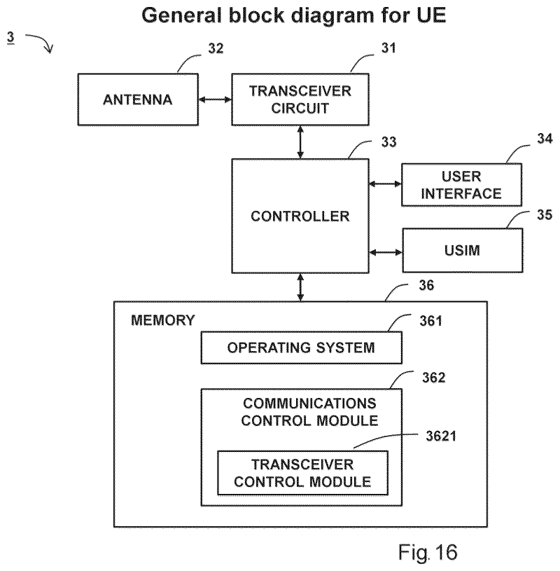

FIG. 16 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### (R)AN Node

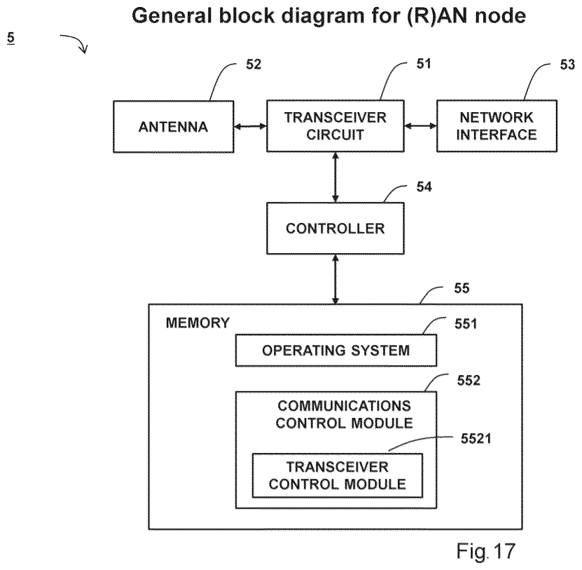

FIG. 17 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

The Current RAN 501 and the Candidate RAN 502 may have same components to the (R)AN node 5. The (R)AN node 5 may be expressed as a RAN node, RAN, (R)AN etc.

### System Overview of (R)AN Node 5 Based on O-RAN Architecture

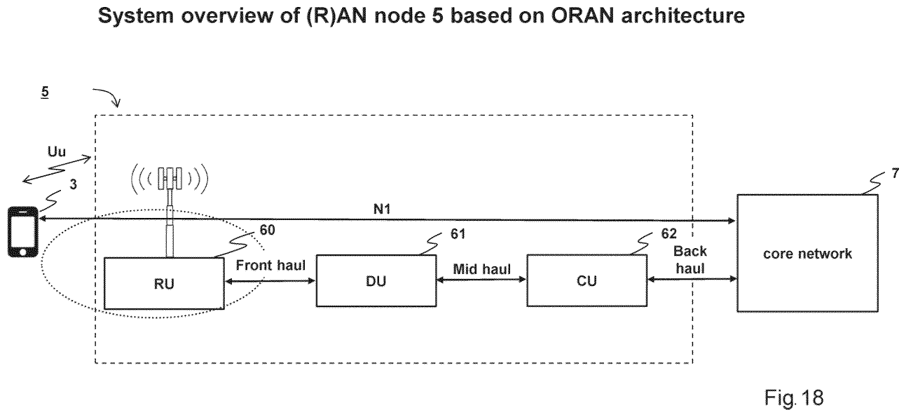

FIG. 18 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionalities to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

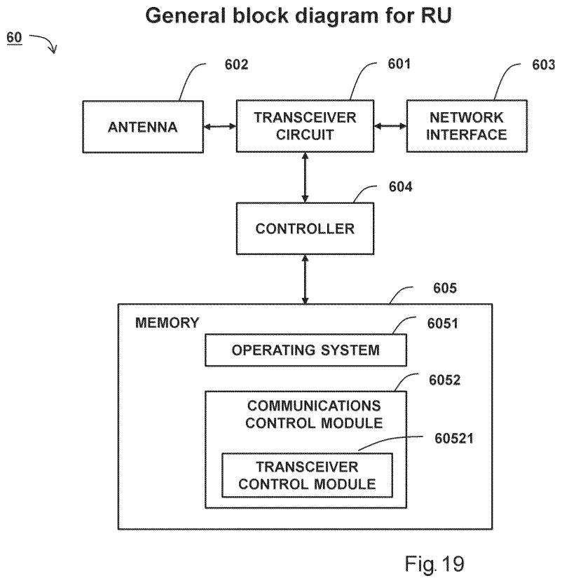

FIG. 19 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

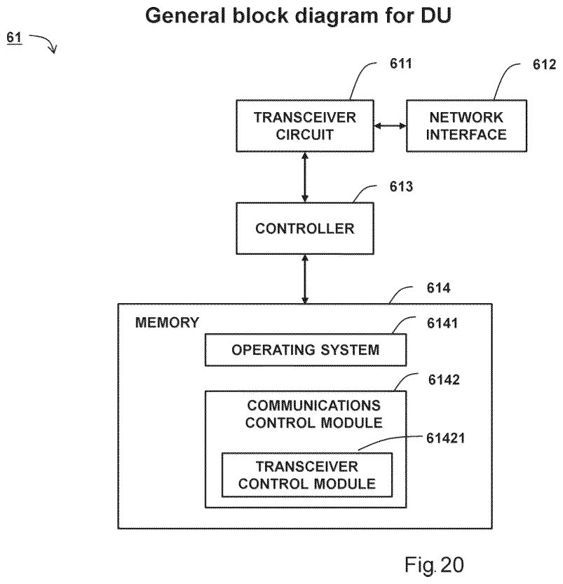

FIG. 20 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### Centralized Unit (CU)

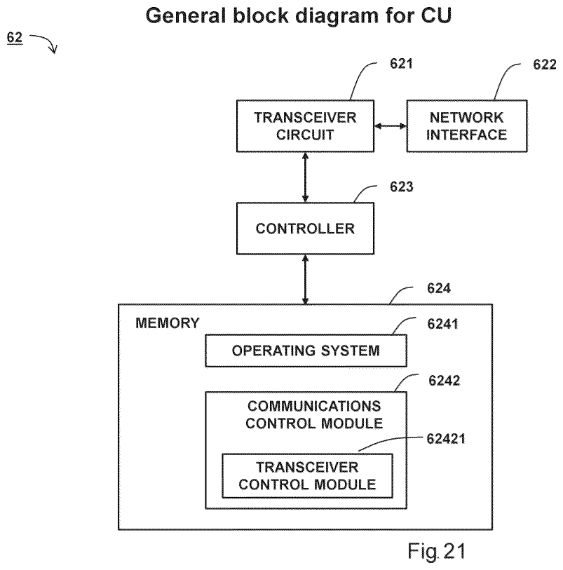

FIG. 21 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

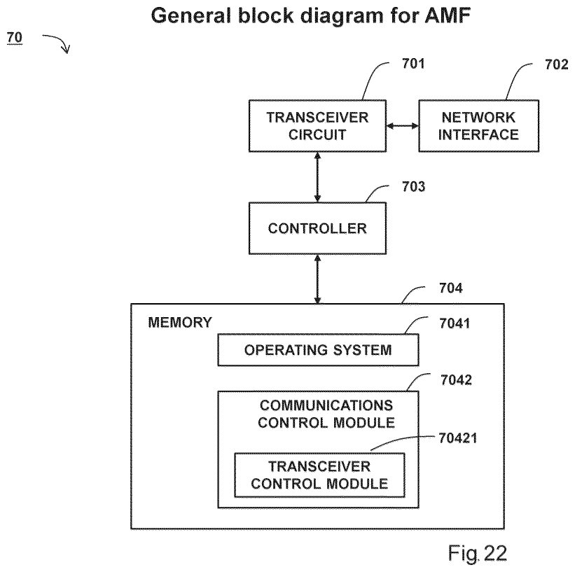

FIG. 22 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### PCF

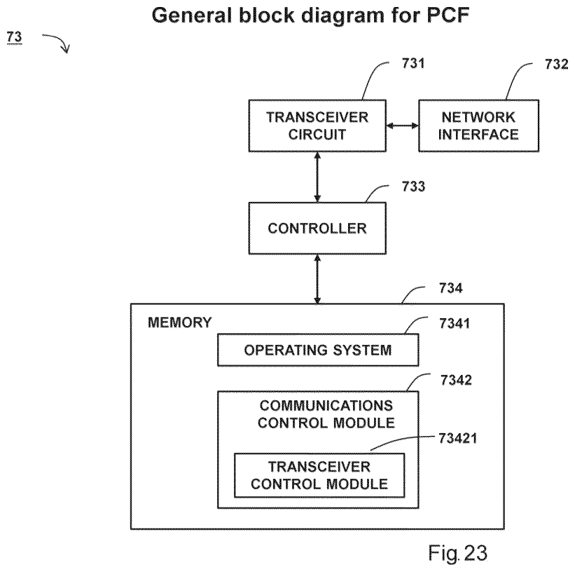

FIG. 23 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### AUSF

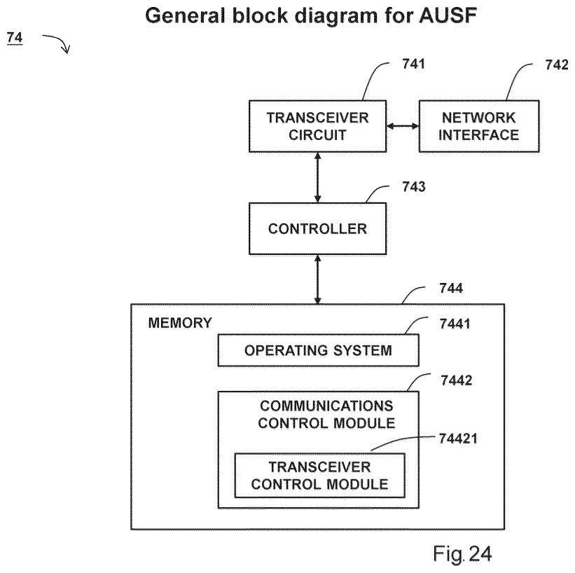

FIG. 24 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### UDM

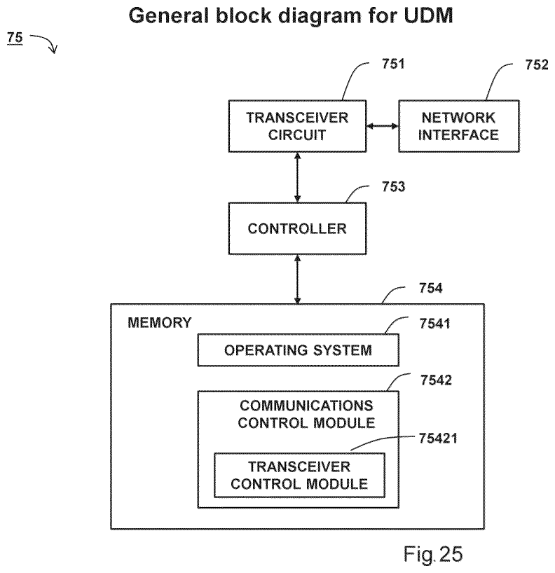

FIG. 25 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### NSSF

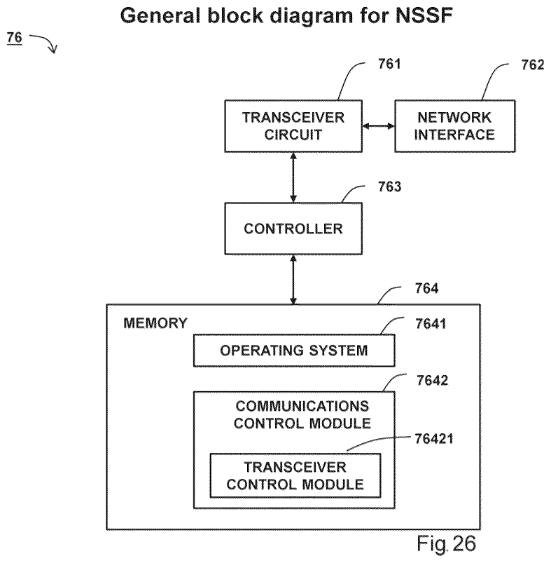

FIG. 26 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functionSharedware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registerShared disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### SUPPLEMENTARY NOTES

The whole or part of the example Aspects disclosed above can be described as, but not limited to, the following supplementary notes.

### Supplementary Note 1

A first Access and Mobility Management Function (AMF), belonging to a first Public Land Mobile Network (PLMN), comprising:
a receiver configured to receive, from a second AMF belonging a second PLMN, a first message including at least first information associated with a proxy request,
a processor configured to select at least one shared Radio Access Network (RAN) from among multiple shared RAN candidates,
a transmitter configured to transmit, to the at least one selected shared RAN, a second message including at least second information associated with the proxy request,
the receiver configured to receive, from the at least one selected shared RAN, an acknowledge message, and
the transmitter configured to transmit, to the second AMF, a third message including at least third information associated with the at least one selected shared RAN.

### Supplementary Note 2

The first AMF according to supplementary note 1, wherein
the acknowledge message includes at least information indicating a capability for the proxy request.

### Supplementary Note 3

The first AMF according to supplementary note 1, wherein
the acknowledge message includes at least routing information of the shared RAN.

### Supplementary Note 4

The first AMF according to supplementary note 1, wherein
the processor is configured to select the at least one shared RAN from among the multiple shared RAN candidates based on the first information.

### Supplementary Note 5

The first AMF according to supplementary note 1, wherein
in a case where the receiver is configured to receive, from a user equipment (UE), a Protocol Data Unit (PDU) Session Establishment Request message,
the transmitter is configured to transmit, to a first Session Management Function (SMF) belonging to the first PLMN, a message including information associated with the proxy request, and
the receiver is configured to receive, from the first SMF, a response message.

### Supplementary Note 6

The first AMF according to supplementary note 1, wherein
in a case of a user equipment (UE) triggered service request or a network triggered service request,
in a case where the receiver is configured to receive, from the second AMF, a second request message,
the transmitter is configured to transmit, to the shared RAN, a first request message including a first Uplink (UL) endpoint identifier of a first User Plane Function (UPF) belonging to the first PLMN if the first AMF decides to include the first UPF in a user plane connection between the UE and a second UPF belonging to the second PLMN, and
in a case where the receiver is configured to receive, from the shared RAN, a second response message,
the transmitter is configured to transmit, to the second AMF, a first response message including a first Downlink (DL) endpoint identifier of the first UPF if the first UPF is included in the user plane connection between the UE and the second UPF.

### Supplementary Note 7

A shared Radio Access Network (RAN) comprising:
a receiver configured to receive, form a first Access and Mobility Management Function (AMF) belonging to a first Public Land Mobile Network (PLMN), a second message including at least second information associated with a proxy request,
a transmitter configured to transmit, to the first AMF, an acknowledge message, wherein
the receiver is configured to receive, from a user equipment (UE), a Radio Resource Control (RRC) message including at least a selected Public Land Mobile Network (PLMN)-Identity, and
a processor is configured to determine whether to transmit a first Next Generation Application Protocol (NGAP) message, to a second AMF belonging to a second PLMN, directly or via the first AMF.

### Supplementary Note 8

The shared RAN according to supplementary note 7, wherein
the acknowledge message includes at least information indicating a capability for the proxy request.

### Supplementary Note 9

The shared RAN according to supplementary note 7, wherein
the acknowledge message includes at least routing information of the shared RAN.

### Supplementary Note 10

The shared RAN according to supplementary note 7, wherein
the processor is configured to include the selected PLMN-Identity in the first NGAP message if the processor is configured to determine to transmit, to the second AMF, the first NGAP message via the first AMF, and
the processor is configured not to include the selected PLMN-Identity in the first NGAP message if the processor is configured to determine to transmit, to the second AMF, the first NGAP message directly.

### Supplementary Note 11

The shared RAN according to supplementary note 7, wherein
the transmitter is configured to transmit, to the first AMF, a request message including information indicating a capability for the proxy request, and
the receiver is configured to receive, from the first AMF, a response message including information indicating the proxy request.

### Supplementary Note 12

The shared RAN according to supplementary note 11, wherein
the request message includes routing information of the shared RAN.

### Supplementary Note 13

The shared RAN according to supplementary note 7, wherein
the receiver is configured to receive, from a first shared RAN, a request message including information indicating a PLMN list which is determined based on a NGAP setup procedure between the first shared RAN and at least one AMF associated with the first shared RAN, and
the transmitter is configured to transmit, to the first shared RAN, a response message including information indicating a PLMN list which is determined based on a NGAP setup procedure between the shared RAN and at least one AMF associated with the shared RAN.

### Supplementary Note 14

The shared RAN according to supplementary note 7, wherein
in a case where the receiver is configured to receive, from a first shared RAN, a HANDOVER Request message,
a processor is configured to determine whether to transmit a NGAP message, to the second AMF, directly or via the first AMF.

### Supplementary Note 15

A second Access and Mobility Management Function (AMF), belonging to second Public Land Mobile Network (PLMN), comprising:
a transmitter configured to transmit, to a first AMF belonging a first PLMN, a first message including at least first information associated with a proxy request, a receiver configured to receive, from the first AMF, a third message including at least third information associated with at least one shared RAN, the at least one shared RAN being selected by the first AMF,
a processor configured to determine whether to transmit a Next Generation Application Protocol (NGAP) message, to the at least one shared RAN, directly or via the first AMF.

### Supplementary Note 16

The second AMF according to supplementary note 15, wherein
in a case where the receiver is configured to receive, from the shared RAN, Handover Required message via the first AMF,
a processor is configured to determine whether to transmit a NGAP message, to the shared RAN, directly or via the first AMF.

### Supplementary Note 17

A method for a first Access and Mobility Management Function (AMF), belonging to a first Public Land Mobile Network (PLMN), the method comprising:
receiving, from a second AMF belonging a second PLMN, a first message including at least first information associated with a proxy request,
selecting at least one shared Radio Access Network (RAN) from among multiple shared RAN candidates,
transmitting, to the at least one selected shared RAN, a second message including at least second information associated with the proxy request,
receiving, from the at least one selected shared RAN, an acknowledge message, and
transmitting, to the second AMF, a third message including at least third information associated with the at least one selected shared RAN.

### Supplementary Note 18

The method according to supplementary note 17, wherein
the acknowledge message includes at least information indicating a capability for the proxy request.

### Supplementary Note 19

The method according to supplementary note 17, wherein
the acknowledge message includes at least routing information of the shared RAN.

### Supplementary Note 20

The method according to supplementary note 17, the method further comprising:
selecting the at least one shared RAN from among the multiple shared RAN candidates based on the first information.

### Supplementary Note 21

The method according to supplementary note 17, wherein
in a case where the receiver is configured to receive, from a user equipment (UE), a Protocol Data Unit (PDU) Session Establishment Request message,
the method comprises transmitting, to a first Session Management Function (SMF) belonging to the first PLMN, a message including information associated with the proxy request, and
the method comprises receiving, from the first SMF, a response message.

### Supplementary Note 22

The method according to supplementary note 17, wherein
in a case of a user equipment (UE) triggered service request or a network triggered service request,
in a case of receiving, from the second AMF, a second request message,
the method comprises transmitting, to the shared RAN, a first request message including a first Uplink (UL) endpoint identifier of a first User Plane Function (UPF) belonging to the first PLMN if the first AMF decides to include the first UPF in a user plane connection between the UE and a second UPF belonging to the second PLMN, and
in a case of receiving, from the shared RAN, a second response message,
the method comprises transmitting, to the second AMF, a first response message including a first Downlink (DL) endpoint identifier of the first UPF if the first UPF is included in the user plane connection between the UE and the second UPF.

### Supplementary Note 23

A method for a shared Radio Access Network (RAN), the method comprising:
receiving, form a first Access and Mobility Management Function (AMF) belonging to a first Public Land Mobile Network (PLMN), a second message including at least second information associated with a proxy request,
transmitting, to the first AMF, an acknowledge message,
receiving, from a user equipment (UE), a Radio Resource Control (RRC) message including at least a selected Public Land Mobile Network (PLMN)-Identity, and
determining whether to transmit a first Next Generation Application Protocol (NGAP) message, to a second AMF belonging to a second PLMN, directly or via the first AMF.

### Supplementary Note 24

The method according to supplementary note 23, wherein
the acknowledge message includes at least information indicating a capability for the proxy request.

### Supplementary Note 25

The method according to supplementary note 23, wherein
the acknowledge message includes at least routing information of the shared RAN.

### Supplementary Note 26

The method according to supplementary note 23, wherein
the method comprises including the selected PLMN-Identity in the first NGAP message if the method comprises determining to transmit, to the second AMF, the first NGAP message via the first AMF, and
the method comprises not including the selected PLMN-Identity in the first NGAP message if the method comprises determining to transmit, to the second AMF, the first NGAP message directly.

### Supplementary Note 27

The method according to supplementary note 26, the method further comprising:
transmitting, to the first AMF, a request message including information indicating a capability for the proxy request, and
receiving, from the first AMF, a response message including information indicating the proxy request.

### Supplementary Note 28

The method according to supplementary note 27, wherein
the request message includes routing information of the shared RAN.

### Supplementary Note 29

The method according to supplementary note 27, wherein
receiving, from a first shared RAN, a request message including information indicating a PLMN list which is determined based on a NGAP setup procedure between the first shared RAN and at least one AMF associated with the first shared RAN, and
transmitting, to the first shared RAN, a response message including information indicating a PLMN list which is determined based on a NGAP setup procedure between the shared RAN and at least one AMF associated with the shared RAN.

### Supplementary Note 30

The method according to supplementary note 27, wherein
in a case of receiving, from a first shared RAN, a HANDOVER Request message,
the method comprises determining whether to transmit a NGAP message, to the second AMF, directly or via the first AMF.

### Supplementary Note 31

A method for a second Access and Mobility Management Function (AMF), belonging to second Public Land Mobile Network (PLMN), the method comprising:
transmitting, to a first AMF belonging a first PLMN, a first message including at least first information associated with a proxy request,
   receiving, from the first AMF, a third message including at least third information associated with at least one shared RAN, the at least one shared RAN being selected by the first AMF,
determining whether to transmit a Next Generation Application Protocol (NGAP) message, to the at least one shared RAN, directly or via the first AMF.

### Supplementary Note 32

The method according to supplementary note 31, wherein
in a case of receiving, from the shared RAN, Handover Required message via the first AMF,
the method comprises determining whether to transmit a NGAP message, to the shared RAN, directly or via the first AMF.

This application is based upon and claims the benefit of priority from Indian patent applications No. 202311006779, filed on Feb. 2, 2023, the disclosure of which is incorporated herein in its entirety by reference.

What is claimed is:

1. A first Access and Mobility Management Function (AMF), belonging to a first Public Land Mobile Network (PLMN), comprising:
a memory storing instructions; and
a processor configured to execute the instructions to:
receive, from a second AMF belonging a second PLMN, a first message including at least first information associated with a proxy request,
select at least one shared Radio Access Network (RAN) from among multiple shared RAN candidates,
transmit, to the at least one selected shared RAN, a second message including at least second information associated with the proxy request,
receive, from the at least one selected shared RAN, an acknowledge message, and
transmit, to the second AMF, a third message including at least third information associated with the at least one selected shared RAN.

2. The first AMF according to claim 1, wherein
the acknowledge message includes at least information indicating a capability for the proxy request.

3. The first AMF according to claim 1, wherein
the acknowledge message includes at least routing information of the shared RAN.

4. The first AMF according to claim 1, wherein
the processor is configured to execute the instructions to select the at least one shared RAN from among the multiple shared RAN candidates based on the first information.

5. The first AMF according to claim 1, wherein
in a case where a Protocol Data Unit (PDU) Session Establishment Request message is received from a user equipment (UE),
the processor is configured to execute the instructions to:
transmit, to a first Session Management Function (SMF) belonging to the first PLMN, a message including information associated with the proxy request, and
receive, from the first SMF, a response message.

6. The first AMF according to claim 1, wherein
in a case of a user equipment (UE) triggered service request or a network triggered service request,
in a case where a second request message is received from the second AMF,
the processor is configured to execute the instructions to transmit, to the shared RAN, a first request message including a first Uplink (UL) endpoint identifier of a first User Plane Function (UPF) belonging to the first PLMN if the first AMF decides to include the first UPF in a user plane connection between the UE and a second UPF belonging to the second PLMN, and
in a case where a second response message is received from the shared RAN,
the processor is configured to execute the instructions to transmit, to the second AMF, a first response message including a first Downlink (DL) endpoint identifier of the first UPF if the first UPF is included in the user plane connection between the UE and the second UPF.

7. A shared Radio Access Network (RAN) comprising:
a memory storing instructions; and
a processor configured to execute the instructions to:
receive, form a first Access and Mobility Management Function (AMF) belonging to a first Public Land Mobile Network (PLMN), a second message including at least second information associated with a proxy request,
transmit, to the first AMF, an acknowledge message,
receive, from a user equipment (UE), a Radio Resource Control (RRC) message including at least a selected Public Land Mobile Network (PLMN)-Identity, and
determine whether to transmit a first Next Generation Application Protocol (NGAP) message, to a second AMF belonging to a second PLMN, directly or via the first AMF.

8. The shared RAN according to claim 7, wherein
the acknowledge message includes at least information indicating a capability for the proxy request.

9. The shared RAN according to claim 7, wherein
the acknowledge message includes at least routing information of the shared RAN.

10. The shared RAN according to claim 7, wherein
the processor is configured to execute the instructions to include the selected PLMN-Identity in the first NGAP message in a case where it is determined to transmit, to the second AMF, the first NGAP message via the first AMF, and
the processor is configured to execute the instruction not to include the selected PLMN-Identity in the first NGAP message in a case where it is determined to transmit, to the second AMF, the first NGAP message directly.

11. The shared RAN according to claim 7, wherein the processor is configured to execute the instructions to:
transmit, to the first AMF, a request message including information indicating a capability for the proxy request, and
receive, from the first AMF, a response message including information indicating the proxy request.

12. The shared RAN according to claim 11, wherein
the request message includes routing information of the shared RAN.

13. The shared RAN according to claim 7, wherein the processor is configured to execute the instructions to:
receive, from a first shared RAN, a request message including information indicating a PLMN list which is determined based on a NGAP setup procedure between the first shared RAN and at least one AMF associated with the first shared RAN, and
transmit, to the first shared RAN, a response message including information indicating a PLMN list which is determined based on a NGAP setup procedure between the shared RAN and at least one AMF associated with the shared RAN.

14. The shared RAN according to claim 7, wherein
in a case where a HANDOVER Request message is received from a first shared RAN,
the processor is configured to execute the instructions to determine whether to transmit a NGAP message, to the second AMF, directly or via the first AMF.

15-16. (canceled)

17. A method for a first Access and Mobility Management Function (AMF), belonging to a first Public Land Mobile Network (PLMN), the method comprising:
receiving, from a second AMF belonging a second PLMN, a first message including at least first information associated with a proxy request,
selecting at least one shared Radio Access Network (RAN) from among multiple shared RAN candidates,
transmitting, to the at least one selected shared RAN, a second message including at least second information associated with the proxy request,
receiving, from the at least one selected shared RAN, an acknowledge message, and
transmitting, to the second AMF, a third message including at least third information associated with the at least one selected shared RAN.

18. The method according to claim 17, wherein
the acknowledge message includes at least information indicating a capability for the proxy request.

19. The method according to claim 17, wherein
the acknowledge message includes at least routing information of the shared RAN.

20. The method according to claim 17, the method further comprising:
selecting the at least one shared RAN from among the multiple shared RAN candidates based on the first information.

21. The method according to claim 17, wherein
in a case of receiving, from a user equipment (UE), a Protocol Data Unit (PDU) Session Establishment Request message,
the method comprises:
transmitting, to a first Session Management Function (SMF) belonging to the first PLMN, a message including information associated with the proxy request, and
receiving, from the first SMF, a response message.

22. The method according to claim 17, wherein
in a case of a user equipment (UE) triggered service request or a network triggered service request,
in a case of receiving, from the second AMF, a second request message,
the method comprises transmitting, to the shared RAN, a first request message including a first Uplink (UL) endpoint identifier of a first User Plane Function (UPF) belonging to the first PLMN in a case where the first AMF decides to include the first UPF in a user plane connection between the UE and a second UPF belonging to the second PLMN, and
in a case of receiving, from the shared RAN, a second response message,
the method comprises transmitting, to the second AMF, a first response message including a first Downlink (DL) endpoint identifier of the first UPF in a case where the first UPF is included in the user plane connection between the UE and the second UPF.

23-32. (canceled)
